(19) United States
(12) Patent Application Publication
(10) Pub. No.: US 2007/0256642 A1
(43) Pub. Date: Nov. 8, 2007

(54) Method and Apparatus for Socking Seed Molluscs and/or for Applying Support Devices to Mollusc Growing Lines

(76) Inventor: Peter Kvietelaitis, Victoria (AU)

Correspondence Address: Robert C. Klinger;Jackson Walker, 901 Main Street, Suite 6000, Dallas, TX, 75202, US

(21) Appl. No.: 10/590,179

(22) PCT Filed: Feb. 18, 2005
(86) PCT No.: PCT/AU05/00217

§ 371 Date: Jun. 18, 2007

(30) Foreign Application Priority Data
Feb. 20, 2004 (AU) 2004900873

(51) Int. Cl. A01K 61/00

(52) U.S. Cl. 119/238

(57) ABSTRACT

The invention I is an apparatus (36) for socking molluscs (20) to produce at least one elongate mollusc growing line (24), including: (a) means (98) for supplying at least one elongate sock (18) for injection with molluscs (20); (b) means (86, 88, 90, 92) for injecting the molluscs (20) into the sock (18); (c) means (64) for driving the sock (18) through the apparatus (36). The invention II is an apparatus for attaching at least one support device (34) to at least one elongate mollusc growing line (24), including: (a) means (130, 132) for providing at least one support device (34) for attachment to the growing line (24): (b) means (120, 124) for releasably holding the growing line (24) at a predefined location: (c) means (124, 138) for applying the support device (34) to the growing line (24) while the growing line (24) is held at the predefined location. The invention III is an apparatus (36) for providing at least one elongate growing line (24), including: (a) means (98) for supplying at least one elongate sock (18) for injection with molluscs (20): (b) means (86, 88, 90, 92) for injecting the molluscs (20) into the sock (18): (c) means (64) for driving the sock (18) through the apparatus (36): (d) means (130, 132) for providing at least one support device (34) for attachment to the growing line (24): (e) means (120, 124) for releasably holding the growing line (24) at a predefined location: (f) means (124, 138) for applying the support device (34) to the growing line (24) while the growing line (24) is held at the predefined location.

### FIELD OF THE INVENTION

The present invention relates to a method and apparatus for use in the aquaculture farming industry, and relates particularly, though not exclusively to a method and apparatus for socking seed or juvenile molluscs, especially mussels, and/or for applying support devices to growing lines prior to the growing lines being suspended in a growing environment.

### BACKGROUND OF THE INVENTION

With increased demand for high quality produce, the aquaculture farming industry has developed smarter and more reliable techniques for culturing and harvesting marine life. Mussels, like other marine life, were historically harvested from the wild. However, as stocks diminished, new methods of farming mussels have evolved. A common mussel farming method utilises growing lines, such as ropes, nets, or the like, which are suspended below the surface of the water in order to collect seed mussels, which attach themselves to the lines in order to grow. After some time seed mussels collect on these lines in dense clusters, in fact at a density which is too large to permit the mussels to mature properly. At this point a mussel farmer may withdraw the lines from the water for harvesting and may then manually, separate, de-clump, grade and inject the immature mussels into a mesh sock, net or the like which usually surrounds a growing rope.

A traditional method of injecting seed mussels into a mesh sock involves the use of a tubular applicator, which is commonly a section of plastic tube having a suitable internal diameter. In use, a mesh sock is manually stretched and applied onto the outer surface of the tube, a free end of the sock is then drawn off one end of the tube and tied ready for injection with seed mussels. A growing rope is then normally threaded through the tube and into the mesh sock ready for injection with mussels. The mussels are injected into the sock through the tube, at the open end thereof, opposite the end where the sock was tied. The process of socking the mussels continues as the tied end of the sock with the internally located growing rope is manually drawn away from the applicator, pulling more sock off the outer surface of the tube, which in turn is filled with injected seed mussels. This process facilitates mussel attachment at a more appropriate density to assist the growth of mussels when they are re-introduced into the water. The mussel density within the sock is determined by the internal diameter of the tubular applicator used during the injection process. As the internal diameter of an applicator is fixed, many applicators with varying internal diameters are generally used by a mussel farmer in order to achieve varying mussel density requirements. Due to the varying density requirements, the process of socking seed mussels has to date only been a manual process.

The use of a mesh sock, which is sometimes perishable, provides a greater surface area for the mussels to attach to as they grow. Over time, mussels grow radially outwardly through the sock, to a size which can be several inches long. As mussels increase in size, those closest to the internal growing rope rely on support from the growing rope itself, by attaching themselves thereto, whilst those disposed radially outwardly thereof rely on attachment to other mussels below them for support. If a mesh sock is utilised, mussels in the vicinity thereof can rely on this sock for support. If the sock is perishable, mussels can only initially rely on the sock for support. After the sock disintegrates, mussels in that vicinity can only rely on support from those mussels beneath them. It is at this point that the entire mussel crop is reliant on the foothold of those mussels (the supporting mussels) that have directly attached themselves to the growing rope. The number of mussels that can actually attach themselves directly to a growing rope is dependant on the diameter or surface area of the growing rope itself. It thus becomes evident that, as mussels grow and hence weight increases, if supporting mussels lose their foothold significant losses of crop can occur as large clusters of mussels fall away from the growing line and are lost.

Losses associated with mussels peeling off or falling away from growing lines will hereinafter generally be referred to as the “slide off effect”.

To minimise losses associated with the slide off effect many methods have been employed in the past. One such method has been to provide additional support to mussels on a growing line, through the insertion of a series of skewers or rods. These skewers, usually wooden, are manually inserted at spaced intervals through the mesh sock or net after the socking process, between the mussels and through the core growing rope (which provides the secure attachment). This results in a series of protrusions extending horizontally from either side of the vertically suspended growing line. These protrusions assist in supporting mussels from slide off by providing a greater attachment area for the mussels, being supported directly in the vicinity of the skewers.

An alternative method for providing additional support to mussels as they grow is described in U.S. Pat. No. 6,520,116, of Jefferds, Ian W, and an embodiment of the same can be seen in FIGS. 9a & 9b of the accompanying representations. This method utilises a planar support plate or disc which is adapted to provide a large horizontal support surface for mussels to attach to when the support plate is attached to a growing line. These plates or discs have a slot for receiving a growing line and a skewer-like projection attached thereto, projecting into and parallel with the slot, to be inserted through the growing line to facilitate attachment thereto. These plates rely on known skewer principles, in that they utilise a skewer for attachment to a growing line. Where these plates differ from the traditional skewer is that the additional support is provided by way of a plate making up one of the horizontal protrusions, instead of both protrusions simply being respective protruding sides of a skewer.

A problem associated with the skewer method, or with devices which utilise a skewer for attachment to a growing line, such as Jefferds, is that the application of a skewer to a growing line traditionally has been a manual process. Due to the nature of the insertion of a skewer through a growing line an automated application process is generally considered not possible. In cases where a mesh sock is used in combination with a growing rope, before attempting to apply a skewer it is required to find an encased, sometimes visually hidden and, more often than not, growing rope that is not centrally located within the sock. The skewer then needs to be inserted through the rope, preferably centrally and horizontally to the rope. Thus this task is usually performed manually after the socking operation and central and horizontal insertion is not always easy to achieve.

An alternative method of attaching plate-like support structures to growing lines (particularly ropes) is described in U.S. Pat. No. 6,578,523, of Gagnon, Gilles, and an embodiment of the same can be seen in FIGS. 8a & 8b of the accompanying representations. Instead of using a skewer-like projection for attachment Gagnon provides a device which utilises a clip arranged within an aperture, at the centre of the device, to facilitate attachment of the device to a growing line. This clip is cylindrical in shape and, in use, has a diameter slightly smaller than the diameter of the growing line for gripping the latter when attached thereto. The clip has an opening bordered by outwardly diverging, resilient arms. During insertion of a growing line the arms flex outwardly into generally V-shaped recesses and return to the rest position in which the growing line is clamped in the clip. This device overcomes the problems associated with having to skewer a growing line, and instead proposes the use of a clip that resiliently clamps around the circumference of a growing line to provide attachment. However, the design of the clip is such that mussels have to be first parted or removed from the growing line in order to affix the device to an exposed section thereon. If the clip is not secured around an unhindered line attachment cannot occur, since the diameter of the clip is smaller than the diameter of the growing line. If the growing line utilises a mesh sock in combination with a growing rope, then the growing rope must be located within the mesh sock and the mesh sock gathered around the rope prior to attaching the device. Due to the steps involved in attaching such a device to a growing line these devices on their own do not lend themselves to an automated application process.

An aquaculture support device having improved attachment means for attachment to many different growing line arrangements is disclosed in Australian Patent Application No. 2003904988 (now PCT/AU04/01238). This application is an earlier application by the present Applicant and is incorporated herein in its entirety. Disclosed in this earlier application are a number of support devices each utilising at least one novel inwardly tapered slot used as an attachment means. The inwardly tapered slot being adapted to receive a growing line and, in use, to wedge the growing line between opposed sides of the slot to facilitate attachment of a device to the growing line. Due to the design of the slot of these devices, as growing lines are introduced into the tapered slot and moved inwardly relative thereto, mussel separation occurs and the taper locates the growing line and facilitates attachment of the device to the same. If a device incorporating the inwardly tapered slot is used with a growing line that is either a mesh sock or a mesh sock applied over a growing rope, the taper attachment of the device facilitates net compression, mussel separation and (if a rope is also used) location of the growing rope within the mesh sock. Thus, in cases where a rope is socked within a mesh net, it is not necessary to first locate the internal rope (which is sometimes hidden) to provide the desired attachment, as the taper will ensure that the rope is located and that the mesh sock is compressed around the rope as force is applied. These devices therefore lend themselves to an automated application process.

In order to automate the application process of these or other support devices onto growing lines, an application machine needs to be able to address a number of issues of which the following are noted. A socked growing line is not always socked uniformly, ie. the diameter of the socked line can vary from one point to another which makes attachment of some devices difficult. The core growing rope within the sock is not usually centrally located and is generally visually hidden making it difficult to attach some devices to the rope as discussed above. Lastly, perishable nets can easily tear or ladder rendering them useless and in need of repair or replacement. Therefore, before mechanical application of these or other support devices can occur one or more of the following tasks must be achieved. Namely, the core growing line must be grabbed and held precisely in position or conveyed to a precise position and then grabbed and held firm ready for attachment of a device. In some cases for attachment to occur, seed mussels must be parted to provide an unhindered section of the growing line to facilitate attachment of a support device at a given location on the growing line. If a mesh sock is used on its own, or is used in combination with an internal growing rope, sock compression around the growing rope may be required simultaneously with the action of parting the mussels attached to the line to facilitate attachment of some devices.

It is therefore an object of the present invention to provide a method and apparatus for socking seed molluscs or the like into growing lines used for cultivation.

A further object of the present invention is to provide a method and apparatus for applying support devices to growing lines used for cultivating molluscs or the like.

Yet a further object of the present invention is to provide a method and apparatus for socking seed molluscs or the like into growing lines and for applying support devices to these growing lines after the same are produced.

### SUMMARY OF THE INVENTION

According to the present invention there is provided an apparatus for socking molluscs to produce at least one elongate mollusc growing line, said apparatus including: means for supplying at least one elongate sock for injection with molluscs; means for injecting said molluscs into said at least one elongate sock; and means for driving said at least one elongate sock through said apparatus; wherein, in use, said injecting means continually socks said molluscs into said at least one elongate sock as said at least one elongate sock is conveyed by said driving means to produce said at least one elongate mollusc growing line.

Preferably said apparatus further includes means for supplying at least one elongate rope into said at least one elongate sock simultaneously with the injection of said molluscs by said injection means, wherein said at least one elongate mollusc growing line produced by said apparatus includes said at least one elongate sock having said injected molluscs and said at least one elongate rope socked therein. It is also preferred that said means for supplying said at least one elongate sock is releasably attached to said apparatus to facilitate ease of application of said at least one elongate sock to said at least one elongate sock supplying means.

In a practical preferred embodiment said means for supplying said at least one elongate sock is at least one socking applicator including an outer tubular body onto the outside of which said at least one elongate sock is loaded, and at least one tubular insert body having a smaller diameter to that of said outer body, said at least one insert body being removably housed within said outer body and, in use, is adapted to receive within an inner surface thereof said at least one elongate sock ready for injection with said molluscs by said injecting means, said at least one insert body providing a density of said molluscs within said at least one elongate mollusc growing line relative to the internal diameter of said inner surface of said at least one insert body. Said at least one socking applicator is capable of providing different mollusc densities within said at least one elongate mollusc growing line by introducing into said at least one socking applicator an insert with a suitable internal diameter.

Preferably said at least one socking applicator further includes at least one sock feed flange for providing frictional resistance to the flow of said at least one elongate sock when the same is drawn away from said outer body of said at least one socking applicator.

It is further preferred that embodiment said injecting means includes at least one hopper for receiving said molluscs, said at least one hopper having at least one opening therein, each opening cooperating with at least one conveyor means, wherein, in use, said at least one conveyor means is adapted to feed said molluscs from within said at least one hopper, through said at least opening and into said at least one socking applicator. It is preferred that said molluscs are fed to said at least one socking applicator via at least one funnel, said at least one funnel being adapted to receive said molluscs from said at least one hopper and, in use, to supply the same to said at least one socking applicator.

In a practical preferred embodiment said apparatus includes one hopper with one slot-like opening arranged at a base of the hopper which co-operates with one conveyor means.

In a further practical preferred embodiment said driving means is at least one drive wheel that is adapted to engage and draw said at least one elongate sock and said at least one elongate mollusc growing line through said at least one socking applicator to, in use, facilitate the continual forming of said at least one elongate mollusc growing line. Preferably said at least one drive wheel cooperates with at least one guide wheel capable of assisting said drawing of said at least one elongate mollusc growing line whilst the same is formed. It is further preferred that said at least one drive wheel includes paired upwardly projecting ridges arranged around the outer periphery of said at least one drive wheel. Said paired ridges define V-shaped recesses between respective pairs that are adapted to accommodate growing lines of varying diameters. Said V-shaped recesses provide said at least one drive wheel with a means of engaging and driving elongate growing lines of varying diameters. In a practical preferred embodiment, said paired ridges include tapered faces in the direction of travel of said at least one drive wheel to assist said at least one drive wheel in grabbing and engaging said at least one elongate mollusc growing line to drive the same through said apparatus.

In yet another practical preferred embodiment said growing lines are adapted to be suspended in water to provide a growing environment for said molluscs.

According to a further aspect of the present invention there is provided an apparatus for attaching at least one support device to at least one elongate mollusc growing line, said apparatus including: means for providing said at least one elongate mollusc growing line; means for providing said at least one support device for attachment to said at least one elongate mollusc growing line; means for releasably holding said at least one elongate mollusc growing line at a predefined location; and means for applying said at least one support device to said at least one elongate mollusc growing line whilst said at least one elongate mollusc growing line is held by said means for releasably holding said at least one elongate mollusc growing line.

Preferably said at least one elongate mollusc growing line is selected from one or more of the following: any suitable growing rope, any suitable growing rope that is socked with a suitable mesh sock, and/or any suitable mesh sock.

In a practical preferred embodiment said at least one elongate mollusc growing line includes an elongate mesh sock which has been socked with molluscs and contains an elongate core growing rope.

Preferably said means for providing said at least one elongate mollusc growing line includes at least one drive wheel that is adapted to engage and draw said at least one elongate mollusc growing line through said apparatus. It is preferred that said at least one drive wheel cooperates with at least one guide wheel capable of assisting said drawing of said at least one elongate mollusc growing line whilst the same is drawn through said apparatus. It is further preferred that said at least one drive wheel includes paired upwardly projecting ridges arranged around the outer periphery of said at least one drive wheel, said paired ridges define V-shaped recesses between respective pairs that are adapted to accommodate growing lines of varying diameters, said V-shaped recesses providing said at least one drive wheel with a means of engaging and driving elongate mollusc growing lines of varying diameters. In a practical preferred embodiment, said paired ridges include tapered faces in the direction of travel of said at least one drive wheel to assist said at least one drive wheel in grabbing and engaging said at least one elongate mollusc growing line to drive the same through said apparatus.

In a practical preferred embodiment said means for providing said at least one support device includes at least one slide which cooperates with said support device applying means, wherein said at least one support device is loaded into said at least one slide ready for application by said support device applying means. It is preferred that said at least one slide is adapted to facilitate the supply of one support device at a time to said support device applying means, said support devices being supplied in a queue to said support device applying means ready for application. In a further practical preferred embodiment said at least one slide is adapted to receive at least one weight, said at least one weight being loaded onto said at least one slide after said at least one support device in order to drive said at least one support device to said support device applying means. In a further practical preferred embodiment more than one support device is loaded onto said at least one slide in a cartridge form.

In yet a further practical preferred embodiment said means for releasably holding said at least one elongate mollusc growing line includes at least one set of mating jaws adapted to be drawn into engagement with one another in order to grab and releasably hold said at least one elongate mollusc growing line. Preferably said at least one set of mating jaws include V-shaped opposed peripheral mating surfaces that, in use, engage and compress said at least one elongate mollusc growing line to facilitate simultaneous mollusc parting about said jaws, mesh sock compression relative to said core growing rope, and location of said core growing rope within said mesh sock to provide an attachment area for said at least one support device. Said attachment area is substantially free from molluscs and ready for attachment of said at least one support device by said support device applying means.

In an alternative practical preferred embodiment said means for releasably holding said at least one elongate mollusc growing line includes at least one jaw plate which can engage and drive said at least one elongate mollusc growing line into and through a nip formed between at least one set of rotating wheels disposed on parallel axes, said at least one set of rotating wheels being adapted to engage and induce a rotational force on said at least one elongate mollusc growing line when said at least one elongate mollusc growing line is driven through said nip formed between said at least one set of rotating wheels. Preferably said at least one jaw plate has a V-shaped peripheral engaging surface and said rotational force induced by said at least one set of rotating wheels engages and compresses said at least one elongate mollusc growing line to facilitate simultaneous mollusc parting about said at least one set of rotating wheels, mesh sock compression relative to said core growing rope, and location of said core growing rope within said mesh sock to provide an attachment area for said at least one support device.

In yet a further alternative practical preferred embodiment said means for releasably holding said at least one elongate mollusc growing line includes at least one control plate defining a generally U-shaped opening therein and including at least one slot bordering each side of said U-shaped opening, said slots defining at least one track for receiving and guiding at least two mating quadrants therein, said U-shaped opening being adapted to receive said at least one elongate mollusc growing line therein and, in use, to engage and drive said at least one elongate mollusc growing line into and through a nip formed between said at least two mating quadrants, said at least two mating quadrants adapted to engage and induce a rotational force on said at least one elongate mollusc growing line when said at least one elongate mollusc growing line is driven through said nip formed between said at least two mating quadrants. Preferably said rotational force induced by said at least two mating quadrants in co-operation with said at least one control plate engages and compresses said at least one elongate mollusc growing line to facilitate simultaneous mollusc parting about said at least two mating quadrants, mesh sock compression relative to said core growing rope, and location of said core growing rope within said mesh sock to provide an attachment area for said at least one support device.

In yet a further practical preferred embodiment said means for applying said at least one support device includes at least one push arm, being adapted, in use, to engage at least one support device from said at least one slide and to push the same into engagement with said at least one elongate mollusc growing line relative to said attachment area provided by said means for releasably holding said at least one elongate growing line. Preferably said push arm is mechanically actuated by at least one ram means or any other suitable means able to drive said push arm.

It is preferred that said at least one support device is selected from one or more of the following group: a planar support plate, a disc-shaped support plate, a support structure incorporating a series of protrusions, a support structure incorporating a ring-like support area, a cage-like structure, and/or any suitable combination thereof. Each of said at least one support devices including any suitable attachment means that is able to facilitate attachment to said at least one elongate mollusc growing line.

In a practical preferred embodiment said at least one elongate mollusc growing line having at least one support device attached thereto is adapted to be suspended in water to provide a growing environment for said molluscs. Said support devices providing additional support area for mollusc attachment.

According to yet a further aspect of the present invention there is provided an apparatus for providing at least one elongate mollusc growing line having at least one support device attached thereto, said apparatus including: means for supplying at least one elongate sock for injection with molluscs; means for injecting said molluscs into said at least one elongate sock; and means for driving said at least one elongate sock through said apparatus, wherein, in use, said injection means continually socks said molluscs into said at least one elongate sock as said at least one elongate sock is conveyed by said driving means to provide said at least one elongate mollusc growing line; means for providing said at least one support device for attachment to said at least one elongate mollusc growing line; means for releasably holding said at least one elongate mollusc growing line at a predefined location; and means for applying said at least one support device to said at least one elongate mollusc growing line whilst said at least one elongate mollusc growing line is held by said means for releasably holding said at least one elongate mollusc growing line.

Preferably said apparatus for providing at least one elongate mollusc growing line having at least one support device attached thereto may include any one or more of the features defined above with respect to said apparatus for socking molluscs and/or said apparatus for attaching at least one support device to at least one elongate mollusc growing line.

In a practical preferred embodiment said at least one elongate mollusc growing line, and/or said at least one elongate mollusc growing line having at least one support device attached thereto, of any one of the preceding paragraphs is adapted to be suspended below the surface of the water in order to provide an attachment surface or support for molluscs or the like during their growth, said at least one support device being attachable to said at least one elongate mollusc growing line at any fixed location, with the body of said at least one support device being adapted to provide additional support area for said molluscs to attach to or be supported by as they grow.

According to yet a further aspect of the present invention there is provided a method for socking molluscs to provide at least one elongate mollusc growing line, said method including the steps of: supplying at least one elongate sock for injection with molluscs; injecting said molluscs into said at least one elongate sock; and conveying said at least one elongate sock simultaneously whilst said molluscs are injected thereinto to produce said at least one elongate mollusc growing line.

Preferably said method further includes the step of simultaneously feeding at least one elongate rope into said at least one elongate sock whilst said molluscs are injected into said at least one elongate sock to produce at least one elongate mollusc growing line having said injected molluscs and said at least one elongate rope socked therein. In a practical preferred embodiment said method further includes the step of suspending said at least one elongate mollusc growing line below the surface of water in order to provide a growing environment for said molluscs during their growth.

According to yet a further aspect of the present invention there is provided a method for attaching at least one support device to at least one elongate mollusc growing line, said method including the steps of: providing said at least one elongate mollusc growing line; providing said at least one support device for attachment to said at least one elongate mollusc growing line; releasably holding said at least one elongate mollusc growing line at a predefined location; and applying said at least one support device to said at least one elongate mollusc growing line whilst said at least one elongate mollusc growing line is releasably held.

Preferably said at least one elongate mollusc growing line is selected from one or more of the following: any suitable growing rope, any suitable growing rope that is socked with a suitable mesh sock, and/or any suitable mesh sock. In a preferred embodiment said at least one elongate mollusc growing line includes an elongate mesh sock which has been socked with molluscs and contains an elongate core growing rope.

In a practical preferred embodiment said step of releasably holding said at least one elongate mollusc growing line provides an attachment area for said at least one support device to be applied to said at least one elongate mollusc growing line, said attachment area being substantially free from molluscs and said elongate core growing rope being located within said elongate mesh sock to facilitate attachment of said at least one support device to said at least one elongate mollusc growing line.

Preferably said at least one support device is selected from one or more of the following group: a planar support plate; a disc-shaped support plate; a support structure incorporating a series of protrusions; a support structure incorporating a ring-like support area; a cage-like structure; and/or, any suitable combination thereof.

It is further preferred that said at least one support device includes any suitable attachment means that is able to facilitate attachment of said at least one support device to said at least one elongate mollusc growing line. Preferably said attachment means is selected from one or more of the following group: an inwardly tapered slot for receiving said at least one elongate mollusc growing line therein and, in use, to wedge said at least one elongate mollusc growing line between opposed sides of said inwardly slot to facilitate attachment thereto; a skewer-like projection; and/or any suitable clip-type arrangement.

In a practical preferred embodiment said method further includes the step of suspending said at least one elongate mollusc growing line having said at least one support device attached thereto below the surface of water in order to provide a growing environment for said molluscs during their growth. Preferably more than one support device is applied to said at least one elongate mollusc growing line at any predefined location. It is further preferred that a body portion of said at least one support device is adapted to provide additional support area for said molluscs to attach to or be supported by as they grow.

According to yet a further aspect of the present invention there is provided a method for providing at least one elongate mollusc growing line having at least one support device attached thereto, said method including the steps of: supplying at least one elongate sock for injection with molluscs; injecting said molluscs into said at least one elongate sock; and conveying said at least one elongate sock simultaneously whilst said molluscs are injected into said at least one elongate sock to produce said at least one elongate mollusc growing line; providing said at least one support device for attachment to said at least one elongate mollusc growing line; releasably holding said at least one elongate mollusc growing line at a predefined location; and applying said at least one support device to said at least one elongate mollusc growing line whilst said at least one elongate mollusc growing line is releasably held.

Preferably said method further includes the step of simultaneously feeding at least one elongate rope into said at least one elongate sock whilst said molluscs are injected into said at least one elongate sock to produce at least one elongate mollusc growing line having said injected molluscs and said at least one elongate rope socked therein. Preferably said step of releasably holding said at least one elongate mollusc growing line provides an attachment area for said at least one support device to be applied to said at least one elongate mollusc growing line, said attachment area being substantially free from molluscs and said elongate core growing rope being located within said elongate mesh sock to facilitate attachment of said at least one support device to said at least one elongate mollusc growing line.

In a practical preferred embodiment said at least one support device is selected from one or more of the following group: a planar support plate; a disc-shaped support plate; a support structure incorporating a series of protrusions; a support structure incorporating a ring-like support area; a cage-like structure; and/or, any suitable combination thereof. Preferably said at least one support device includes any suitable attachment means that is able to facilitate attachment of said at least one support device to said at least one elongate mollusc growing line. It is further preferred that said attachment means is selected from one or more of the following group: an inwardly tapered slot for receiving said at least one elongate mollusc growing line therein and, in use, to wedge said at least one elongate mollusc growing line between opposed sides of said inwardly slot to facilitate attachment thereto; a skewer-like projection; and/or any suitable clip-type arrangement.

In a further practical preferred embodiment said method further includes the step of suspending said at least one elongate mollusc growing line having said at least one support device attached thereto below the surface of water in order to provide a growing environment for said molluscs during their growth. Preferably more than one support device is applied to said at least one elongate mollusc growing line at any predefined location. Preferably a body portion of said at least one support device is adapted to provide additional support area for said molluscs to attach to or be supported by as they grow.

### BRIEF DESCRIPTION OF THE DRAWINGS

In order that the invention may be more clearly understood and put into practical effect there shall now be described in detail preferred constructions of an apparatus for socking seed molluscs and/or for applying support devices to growing lines used for cultivating molluscs in accordance with the invention. The ensuing description is given by way of non-limitative examples only and is with reference to the accompanying drawings, wherein:

FIG. 1a is a perspective view of a prior art socking applicator shown loaded with a mesh sock ready for use;

FIG. 1b is a cross-sectional perspective view of the socking applicator of FIG. 1, shown in use in a first mode of operation of socking seed mussels;

FIG. FIG. 1c is a cross-sectional perspective view of the socking applicator of FIG. 1, shown in use in a second mode of operation of socking seed mussels;

FIG. 2 is a perspective view of a mollusc culture growing arrangement showing a growing line suspended beneath the surface of the water in order to provide support for molluscs as they grow;

FIG. 3 is a perspective view of an apparatus for socking seed molluscs and/or for applying support devices to growing lines made in accordance with a first preferred embodiment of the invention, and suitable for providing a growing line for use in the mollusc growing arrangement shown in FIG. 2;

FIG. 4a is a cross-sectional view of the socking applicator of the apparatus of FIG. 3, shown being fitted to the apparatus;

FIG. 4b is a similar view to that of FIG. 4a, this time showing the socking applicator fitted to the apparatus of FIG. 3;

FIG. 5a is an enlarged partial view of the apparatus of FIG. 3, showing the support device application region of the apparatus in operation after having applied a support device and ready to apply a further support device;

FIG. 5b is a perspective view of one of the support devices circled in FIG. 5a, the subject of which is disclosed in Australian Patent Application No. 2003904988 (now PCT/AU04/01238);

FIG. 5c is a similar view to that of FIG. 5a, showing the apparatus in a further mode of operation applying a further support device;

FIG. 5d is an enlarged view of the circled region of FIG. 5c;

FIG. 6a is a perspective view of an apparatus for socking seed molluscs and/or for applying support devices to growing lines made in accordance with a second preferred embodiment of the invention, also suitable for providing a growing line for use in the mollusc growing arrangement shown in FIG. 2;

FIG. 6b is an enlarged view of the circled region of FIG. 6a;

FIG. 6c is a perspective view from beneath of the apparatus shown in FIG. 6a;

FIG. 6d is an enlarged view of the circled region of FIG. 6c;

FIG. 6e is a plan view of the apparatus of FIG. 6a;

FIG. 6f is a similar view to that of FIG. 6e showing the apparatus in a first mode of operation;

FIG. 6g is a similar view to that of FIGS. 6e and 6f, this time showing the apparatus in enlarged view in a further mode of operation;

FIG. 7a is a perspective view of an apparatus for socking seed molluscs and/or for applying support devices to growing lines made in accordance with a third preferred embodiment of the invention, also suitable for providing a growing line for use in the mollusc growing arrangement shown in FIG. 2;

FIG. 7b is a perspective view from beneath of the apparatus of FIG. 7a;

FIG. 7c is a similar view to that of FIG. 7b, showing the apparatus in a first mode of operation;

FIG. 7d is a plan view of the apparatus of FIG. 7a;

FIG. 7e is a similar view to that of FIG. 7d, showing the apparatus in a further mode of operation;

FIG. 7f is an enlarged view of the circled region of FIG. 7e;

FIG. 8a is a plan view of a support device disclosed in U.S. Pat. No. 6,578,523, of Gagnon, suitable for application by the apparatus of FIGS. 3, 6a or 7a;

FIG. 8b is a side view of the support device of FIG. 8a;

FIG. 9a is a plan view of a support device disclosed in U.S. Pat. No. 6,520,116, of Jefferds, suitable for application by the apparatus of FIGS. 3, 6a or 7a;

FIG. 9b is a side view of the support device of FIG. 9a;

FIG. 10 is an enlarged perspective view of the support device application area of an apparatus for socking seed molluscs and/or for applying support devices to growing lines made in accordance with a fourth preferred embodiment of the invention, and also suitable for providing a growing line for the mollusc growing arrangement shown in FIG. 2;

FIG. 11a is an enlarged view of the socking application region of the apparatus of FIGS. 3, 6a, 7a or 10;

FIG. 11b is an enlarged view of the circled region of FIG. 11a;

FIG. 11c is an enlarged cross-sectional view of a further circled region of FIG. 11a;

FIG. 12a is a perspective view of a preferred embodiment of the drive wheel of the apparatus of FIGS. 3, 6a, 7a or 10;

FIG. 12b is a plan view of the drive wheel of FIG. 12a;

FIG. 12c is a side view of the drive wheel of FIG. 12a;

FIG. 12d is a cross-sectional view of the drive wheel of FIG. 12a, shown driving a growing line having a small diameter; and

FIG. 12e is a similar view to that of FIG. 12d, shown driving a growing line with a larger diameter.

### DETAILED DESCRIPTION OF THE PREFERRED EMBODIMENTS

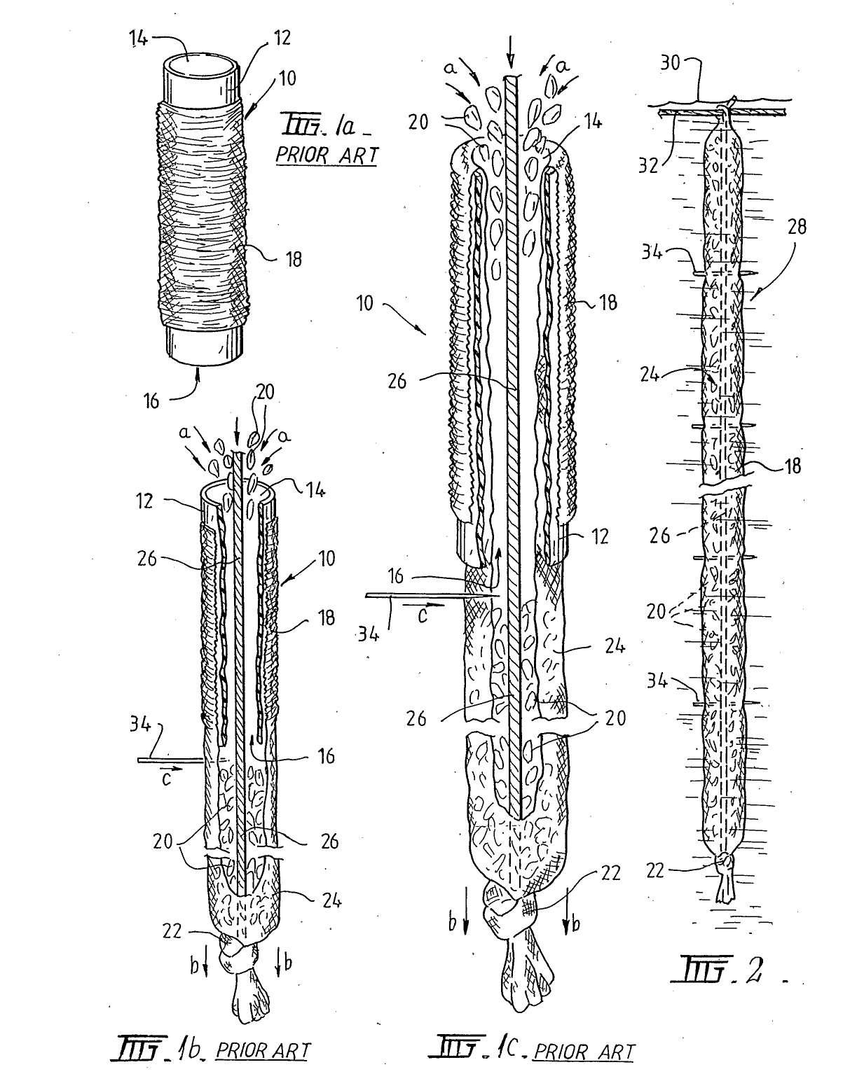

Referring now to the drawings, wherein like reference numerals correspond to like parts throughout, in FIG. 1a there is shown a prior art mussel socking applicator 10, having a tubular body 12 defining a first and second tube opening 14,16. Applied in a stretched state to the outer surface of body 12 of socking applicator 10 is an elastic mesh sock 18. Mesh sock 18 is a net-like stocking and may be perishable if so desired depending on its application. In known methods of cultivating mussels, such as those described above, socking applicator 10 has traditionally been used in one of two ways in order to manually inject seed mussels 20 into mesh sock 18. In FIG. 1b there is shown a first mode of operation of socking applicator 10, being used to manually inject and sock seed mussels 20 into mesh sock 18. In this first mode of operation, mesh sock 18 has been drawn off an end of socking applicator 10, at second tube opening 16, and a knot 22 has been tied in mesh sock 18 to enclose the same ready for injection with mussels 20. In use, in this first mode of operation, the process of socking mussels 20 into mesh sock 18 is achieved by manually injecting mussels 20 into socking applicator 10, through first tube opening 14 in the direction of arrows a. As mussels 20 are injected into socking applicator 10 they pass through socking applicator 10, out second tube opening 16 and into mesh sock 18 relative to the end enclosed by knot 22. The socking process is then continued by pulling more of mesh sock 18 away from socking applicator 10 in the direction of arrows b. The action of pulling mesh sock 18 away from socking applicator 10 is done simultaneously with the process of injecting mussels 20 into socking applicator 10 which ensures that mesh sock 18 is continually filled with mussels 20 as the same is pulled away from socking applicator 10. When mesh sock 18, socked with mussels 20, reaches a predefined length, or when mesh sock 18 has completely pulled away from socking applicator 10, the filled mesh sock 18 becomes a growing line 24 that resembles a long sausage which is tied to enclose its open end and is later used for culturing mussels 20. If growing line 24 reaches a desired length before mesh sock 18 is completely pulled away from socking applicator 10, mesh sock 18 can be cut and then tied. Alternatively, if growing line 24 utilises all of loaded mesh sock 18 which has been completely pulled away from socking applicator 10, growing line 24 is simply tied ready for cultivation.

If desired, and as shown in the representations, growing line 24 may also include a core growing rope 26. Growing rope 26 provides additional support to mussels 20 for attachment as they grow and also strengthens overall growing line 24. If mesh sock 18 is perishable, growing rope 26 is essential to growing line 24 as when mesh sock 18 disintegrates only growing rope 26 remains. In use, growing rope 26 may be inserted into mesh sock 18 simultaneously with the process of injecting mussels 20 through first tube opening 14 of socking applicator 10. As mesh sock 18 is elastic the same will constrict around growing rope 26 and mussels 20 as growing line 24 is formed, ensuring that eventual growing line 24 is maintained. Alternatively, growing rope 26 may be inserted through socking applicator 10, before mussels 20 are injected, and may be tied together with mesh sock 18 to form knot 22.

A second mode of operation of socking applicator 10 is shown in FIG. 1c. In this alternative mode of operation, the process of forming growing line 24 is similar to that of the first mode of operation shown in FIG. 1b. However, here instead of mesh sock 18 being pulled away from the end of socking applicator 10 at second tube opening 16, mesh sock 18 has been pulled over and into first tube opening 14, and through socking applicator 10. In this mode of operation, growing line 24 is formed within socking applicator 10, meaning mussels 20 are socked internally of socking applicator 10. This process provides greater control over the density of mussels 20 within growing line 24. The overall density being limited to that of the internal diameter of socking applicator 10. In practice, if growing lines 24, with varying densities are required, more than one socking applicator 10 would be used. Each socking applicator 10 having a different internal diameter.

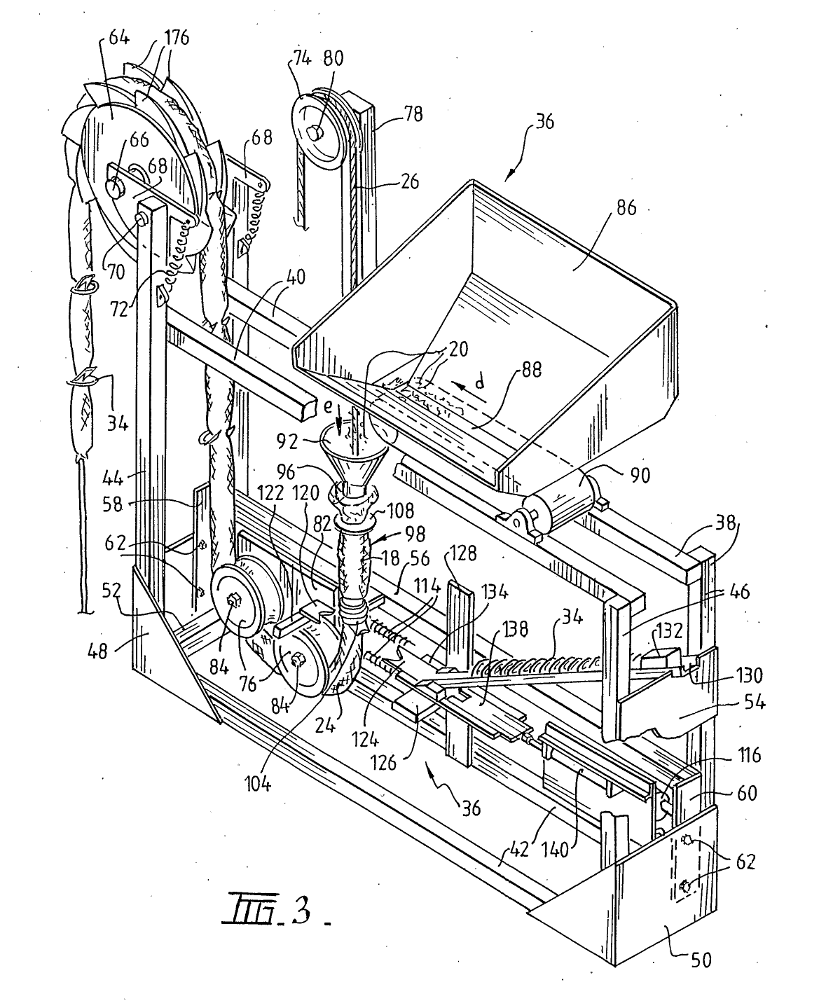

In FIG. 2 there is shown a mollusc growing arrangement 28 suitable, for example, for growing mussels 20. Mollusc growing arrangement 28 includes a growing line 24 vertically suspended below the surface of the water 30 to provide a harvesting support media for mollusc cultivation. In practice a plurality of growing lines 24, commonly referred to as “droppers”, are suspended below the surface of water 30 to provide a large cultivation area for mollusc growth. Growing line 24 is suspended from a substantially horizontal support line 32. Support line 32 is generally suspended beneath the water surface 30 between a pair of buoys (not shown). Vertical support lines (not shown) are usually attached to the buoys and are anchored to the seabed (not shown) in order to maintain the overall mollusc growing arrangement 28 at a chosen location.

As already discussed, growing line 24 may consists of growing rope 26 and mussels 20 which have been socked with mesh sock 18. Although shown in mollusc growing arrangement 28 as each including growing rope 26 and mesh sock 18, growing line 24 may be embodied as a growing rope 26 or mesh sock 18 used on their own. Similarly, growing line 24 may consist of one or more alternative growing media (not shown), used on their own or in combination, and as such the invention is not intended to be limited to any specific example shown.

A general discussion of mussel cultivation utilising vertically suspended growing lines has already been provided in the initial paragraphs of this specification and is herein incorporated with reference to the present discussion.

What is also shown attached to growing line 24 (FIGS. 1b to 2) and positioned at spaced-apart locations thereon are a plurality of support devices 34. In mollusc growing arrangement 28 (FIG. 2), support devices 34 are embodied as skewers which provide additional support for mussels 20 to attach to, as they grow. In harvesting use, when support devices 34 are attached to growing line 24 and placed in the environment of mollusc growing arrangement 28, mussels 20 are not only able to attach themselves to other mussels 20, growing rope 26 and mesh sock 18, but can also attach themselves to support devices 34 for additional support. Support devices 34 provide horizontal support projections for mussels 20, that emanate from vertically suspended growing line 24. This horizontal attachment of mussels 20 helps to reduce losses associated with the slide off effect.

In FIGS. 1b & 1c, a single support device 34 is shown being applied to growing line 24 after a section thereof has been formed. In practice, if support device 34 is embodied as a skewer as shown, support device 34 is manually attached to growing line 24 by inserting the same through mesh sock 18 and core growing rope 26 in the direction of arrow c. A discussion of the traditional act of skewering a growing line 24 and the problems associated therewith has already been provided in the initial paragraphs of this description and is incorporated herein with reference to the present discussion.

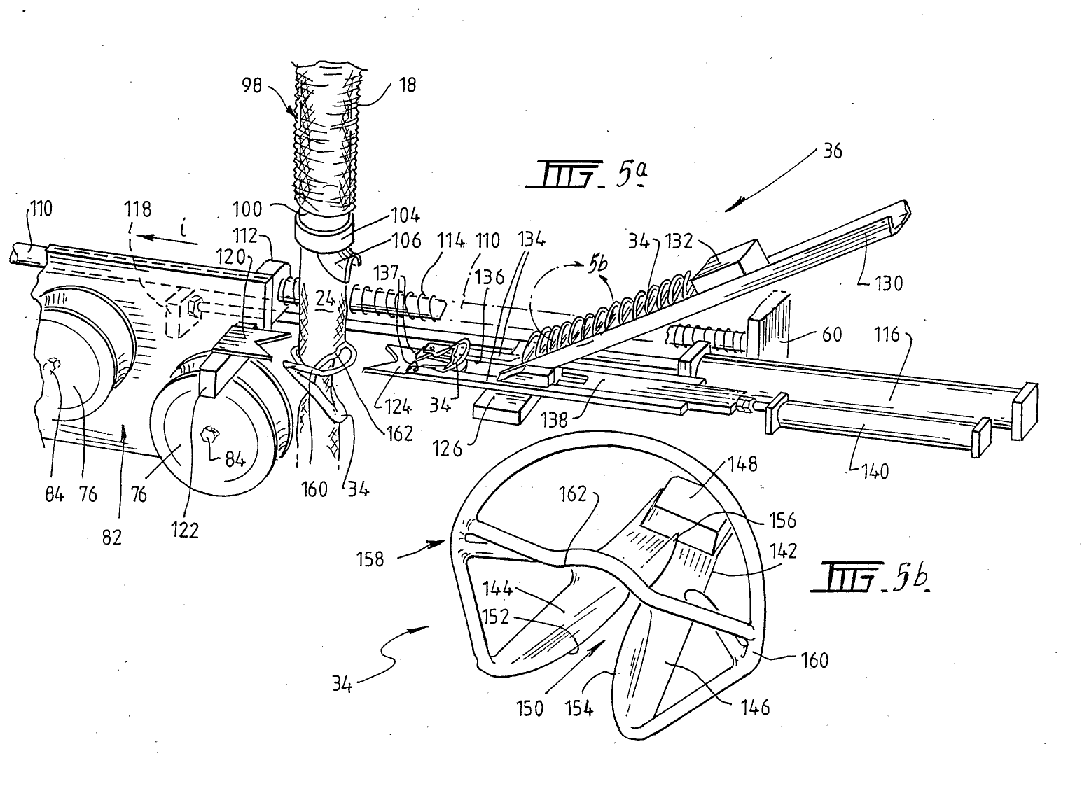

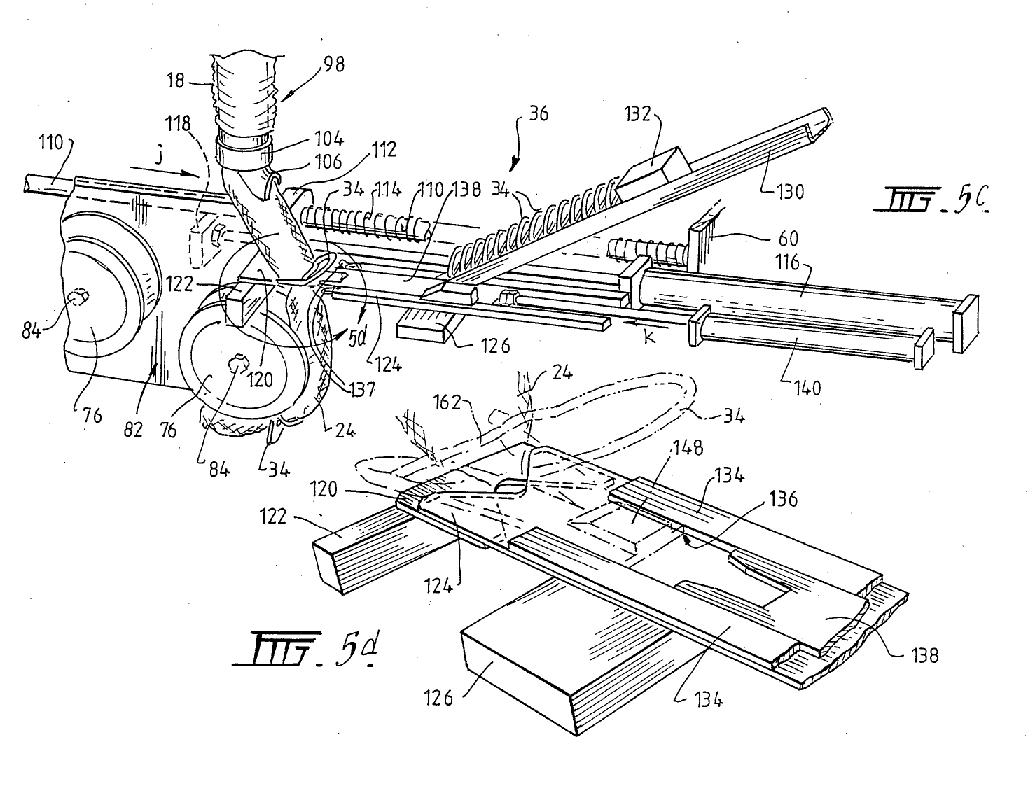

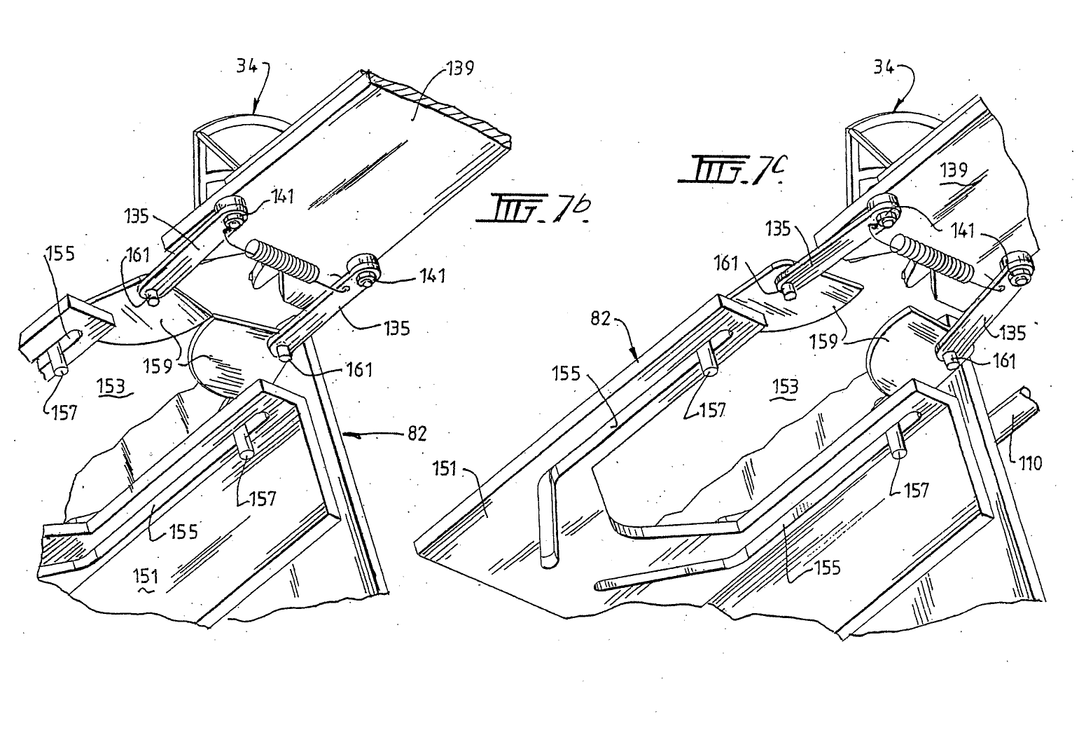

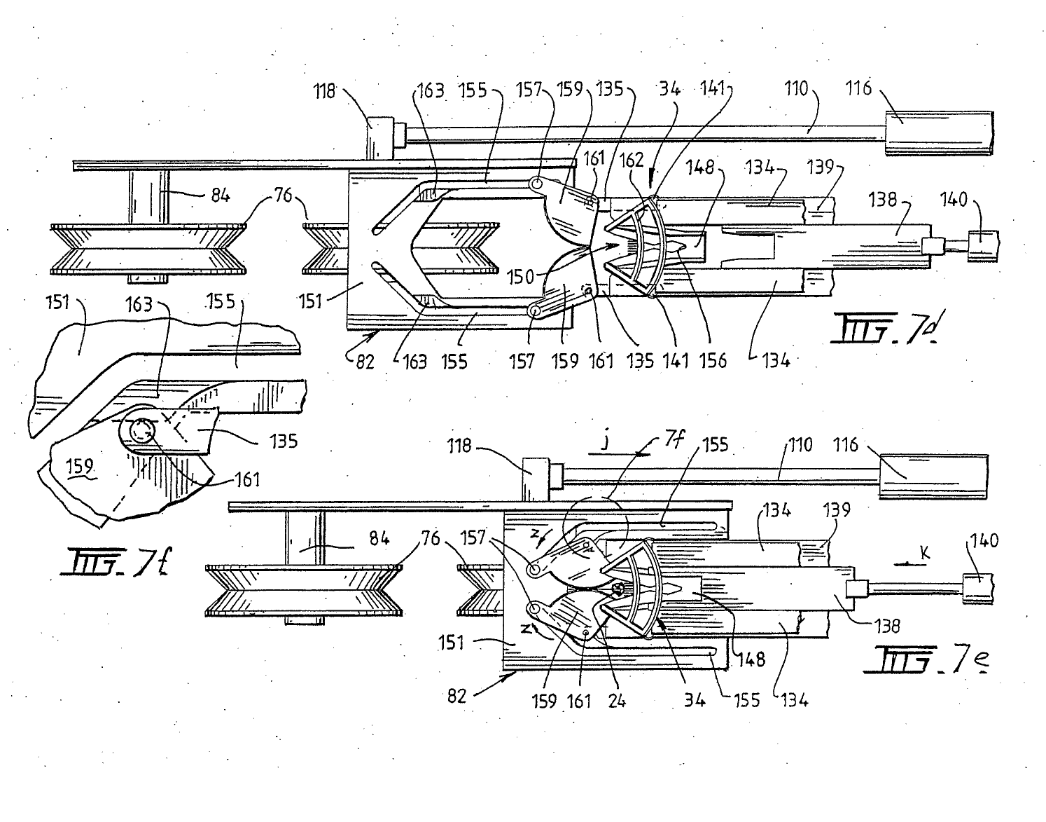

Although shown in FIGS. 1b to 2 as being a skewer, it is to be understood that support devices 34 can be any suitable support means, such as those disclosed in U.S. Pat. No. 6,578,523 (FIGS. 8a & 8b) and U.S. Pat. No. 6,520,116 (FIGS. 9a & 9b), or any of the support devices disclosed in the present Applicant's own earlier Australian Patent Application No. 2003904988 [now PCT/AU04/01238] (for example, the support device shown in FIG. 5b, which will be discussed in detail in the latter part of the present description with reference to the present invention). A discussion of each of the abovementioned support devices and their benefits, application and/or limitations has already been provided and is incorporated herein with reference to the present discussion.

Referring now to FIG. 3, wherein there is shown an apparatus 36 for socking seed molluscs, especially mussels 20, and/or for applying support devices 34 to growing lines 24 made in accordance with a first preferred embodiment of the invention, and suitable for providing a growing line 24 for use in the mollusc growing arrangement 28 shown in FIG. 2. Apparatus 36 includes a generally rectangular frame 38 having a pair of top and bottom frame rails 40,42 and a pair of left and right frame rails 44,46. At the base of apparatus 36 is a pair of reinforcement plates 48,50 and a left side rail 52 and a right side rail (not shown) each secured to respective left and right rails 44,46 and bottom rails 42 to provide rigid support for apparatus 36. Frame 38 also includes a right side reinforcement plate 54 secured to right rails 46 and a horizontal assembly support rail 56 attached at its ends 58,60 to respective reinforcement plates 48,50 by fasteners 62, for example, bolts with cooperating nuts, as shown.

A large drive wheel 64, which is mechanically driven by any suitable means (not shown), is arranged between left rails 44 relative to their upper most points and above top rails 40. Drive wheel 64 rotates relative to its axle 66 which is connected to a pair of supports 68. Supports 68 are pivotally movable with respect to left rails 44 relative to a pair of support pivots 70. Connected to respective supports 68, opposite axle 66, are springs 72, whose opposite ends are connected to respective left rails 44. The arrangement of drive wheel 64, axle 66, supports 68, pivots 70 and springs 72 is such that drive wheel 64 is spring tensioned to assist the operation of apparatus 36 relative to growing line 24 as the same is drawn through apparatus 36 by drive wheel 64. A discussion of the benefit of this tensioned spring arrangement will be provided later. However, it is to be understood that this spring tensioned arrangement of drive wheel 64 is not essential to the invention as the same or similar benefits (discussed later) can be achieved in many different ways, for example, means (not shown) separate from drive wheel 64 could provide the required spring tension relative to growing line 24.

Also included on apparatus 36 is a rope feed wheel 74 for feeding growing rope 26, and a pair of growing line guide wheels 76. Rope feed wheel 74 is pivotally connected to an upright frame extension 78 by a feed wheel pivot 80. Upright extension 78 protrudes and extends vertically upwards from one of top rails 40 and is secured to the same. Guide wheels 76 are pivotally connected to a movable applicator assembly 82 via guide wheel pivots 84.

The remaining components of apparatus 36 will now be discussed with reference to two distinct separate operational regions of apparatus 36, namely, the seed mollusc socking region and the support device application region of apparatus 36. It is to be understood that although apparatus 36 is shown as including both of these two distinct regions in one unit, and hence both are able to be operated simultaneously, each of these regions as now will be described can be operated independently. Similarly, apparatus 36 may be embodied as only including one of the two distinct regions, meaning apparatus 36 could just be a socking apparatus 36 or a support device application apparatus 36. The components as already defined being components that would be common to either apparatus 36 if embodied as separate units.

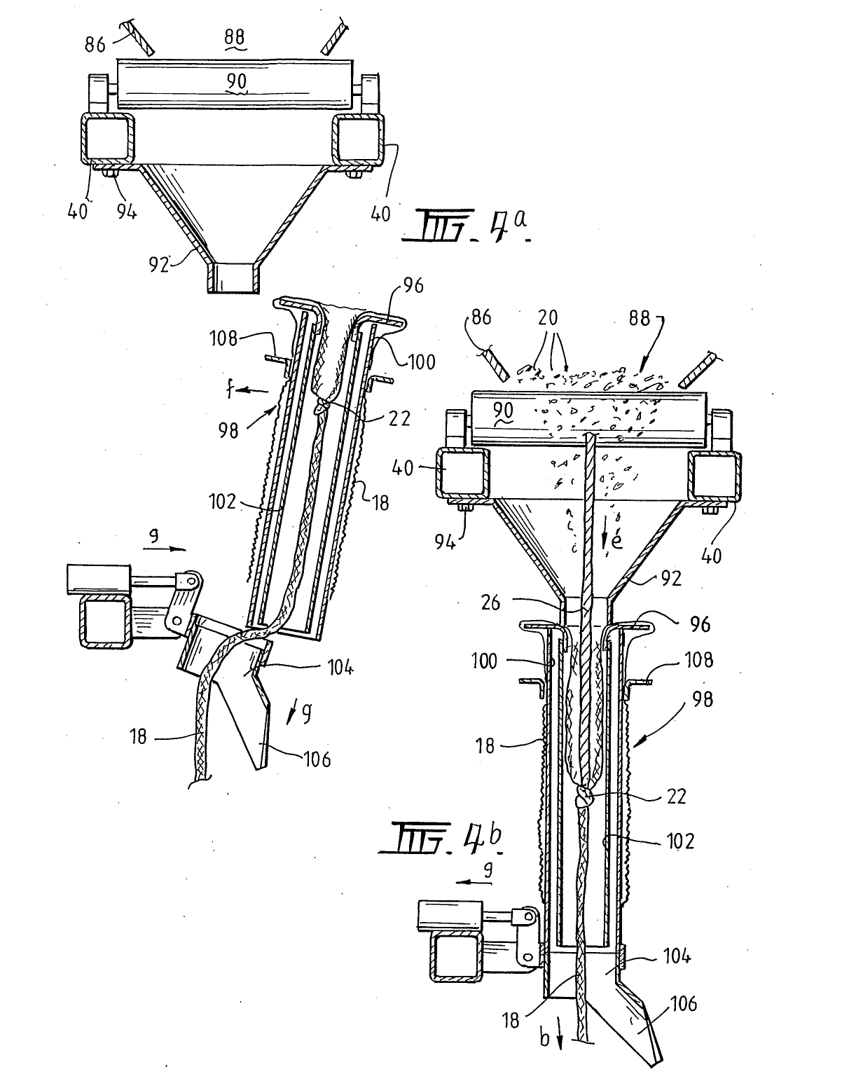

The seed mollusc socking region of apparatus 36 shall now be described with reference to FIGS. 3, 4a, 4b, 11a and 11c. In FIG. 3 there is shown a hopper 86 for supplying apparatus 36 with seed mussels 20. Hopper 86 includes an elongate slot-like opening 88 on its bottom edge which broadens at its left side to provide a larger opening therein. Hopper 86 is arranged above a conveyor 90 which is secured to top rails 40 of apparatus 36. In use, when conveyor 90 is driven by any suitable means (not shown), mussels 20 travel along conveyor 90 and out the left side of opening 88 in the direction of arrow d (FIG. 3). Mussels 20 then fall by gravity, in the direction of arrows e (FIGS. 3, 4b & 11a), into the broad end of a socking funnel 92 which is secured to top rails 40 by bolts 94. The narrow end of socking funnel 92 abuts against a sock feed flange 96 which is part of a removable tubular socking applicator 98. The arrangement of socking funnel 92 and flange 96 of socking applicator 98 is such that mussels 20 conveyed out of hopper 86, through opening 88, fall through socking funnel 92 and flange 96 and finally into socking applicator 98.

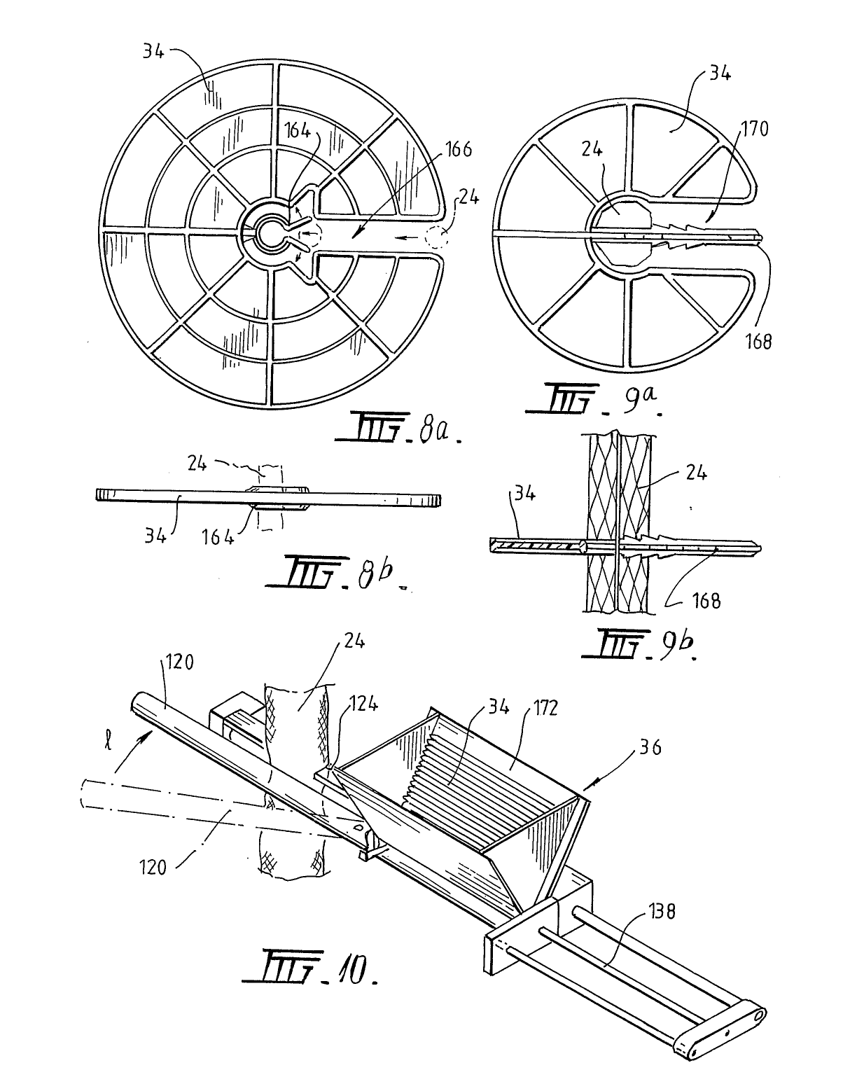

As best seen in FIGS. 4a, 4b and 11c, removable socking applicator 98 includes a tubular outer body 100 which is adapted to receive a tubular insert 102, having a smaller diameter than outer body 100. The downwardly extending opening in feed flange 96 is substantially matched to the internal diameter of insert 102 to preferably form a frictional join there between. Flange 96 is shaped such that when flange 96 is connected to insert 102 and insert 102 is positioned within outer body 100, flange 96 rests on outer body 100 to maintain insert 102 in position. Socking applicator 98, consisting of outer body 100, insert 102 and flange 96, constitutes a separate removable entity as can be seen in FIG. 4a. When attached to apparatus 36, in the direction of arrow f the end of outer body 100 of socking applicator 98 opposite flange 96 sits in a coupling 104 which has a downwardly extending skirt 106. Coupling 104 is movable in the direction of arrows g in order to provide ease of adaptation and removal of socking applicator 98. In use, when outer body 100 is loaded with mesh sock 18, or when outer body 100 of socking applicator 98 requires re-loading with a new mesh sock 18, socking applicator 98 can either be adapted or removed with the assistance of coupling 104 by moving the same in the direction of arrows g.

The process of loading socking applicator 98 with mesh sock 18 ready for use first involves the application of mesh sock 18 onto the external surface of outer body 100, as in the case of the prior art applicator 10 described above with reference to FIGS. 1a to 1c. Where socking applicator 98 differs from prior art socking applicator 10 is the inclusion of insert 102 and the cooperating feed flange 96. In use, when applied to the present socking applicator 98, mesh sock 18 is required to pass over and through feed flange 96 and into insert 102. The opening of mesh sock 18 is sealed by knot 22 and pushed into insert 102 ready for injection with growing rope 26 (if required) and seed mussels 20. When drawn through socking applicator 98 in the direction of arrow b (FIG. 4b), feed flange 96 provides a certain amount of resistance to the flow of mesh sock 18, which in turn provides tension to mesh sock 18 as the eventual growing line 24 is formed which assists the socking action. By including insert 102 the varying density requirements of different socking actions, as described earlier, can be achieved in a novel manner. That is, only one outer body 100, loadable with mesh sock 18 is required to be adaptable with coupling 104 of apparatus 36. The single outer body 100 acts as a standardised cartridge for loading mesh sock 18, whereas more than one insert 102, each cooperating with a matching feed flange 96, can be used to provide the varying mussel density requirements. The required density being achieved by introducing into outer body 100 an insert 102 with a suitable internal diameter.

An additional movable restricting flange 108 is also depicted in the drawings. This restricting flange 108 is preferably included to assist the socking action by providing added resistance to mesh sock 18. Restricting flange 108 works in conjunction with feed flange 96 in order to provide a predetermined amount of frictional tension against the action of mesh sock 18 as the same is drawn through socking applicator 98 after passing under restricting flange 108. This frictional tension ensures that mesh sock 18 does not flow to freely during the socking action. Flange 108 can also be mechanically raised (if desired) in the direction of arrows h (FIG. 11c) so as to lock mesh sock 18 against the lower side of feed flange 96 when required in order to prevent mesh sock 18 displacement. This feature may be required when apparatus 36 is stopped for any reason.

The second distinct separate operational region of apparatus 36, namely the support device application region, shall now be described with reference to FIGS. 3 and 5a to 5d. In FIG. 3 it can be seen that applicator assembly 82 of apparatus 36 is adapted to be movable with respect to a pair of guide rods 110. Guide rods 110 are arranged parallel to each other, one on top of the other, and extend between respective horizontal assembly support rail ends 58,60. Applicator assembly 82 includes four guiding flanges 112 (FIGS. 5a and 5c), two associated with each guide rod 110, positioned on left and right sides of assembly 82, which receive respective guide rods 110 to facilitate left and right horizontal movement of applicator assembly 82 in the direction or arrows i,j (FIGS. 5a & 5c). Applicator assembly 82 is biased to a rest position (FIG. 5a) in the direction of arrow i by a pair of springs 114. Springs 114 fit over and surround respective guide rods 110 and extend from horizontal assembly support rail end 60 and act against the two right side guiding flanges 112 of applicator assembly 82. An assembly ram 116, actuated by any suitable means (not shown), connected to frame 38 at one end and to applicator assembly 82 via a support 118 at its other end, draws applicator assembly 82 to a working position (FIG. 5c) in the direction or arrow j. When the actuation force of assembly ram 116 is released, springs 114 facilitate movement of applicator assembly 82 along guide rods 110 back to the rest position of FIG. 5a.

It is to be understood that although springs 114 are shown and used as the means in which applicator 82 is able to return to the rest position of FIG. 5a, other means (not shown) could be used to facilitate the same result. For example, a second assembly ram (not shown) could return applicator assembly 82 to the rest position, or similarly, assembly ram 116 could be embodied as a ram capable of working in both directions i,j, and as such the invention is not intended to be limited to the specific example as shown.

In order to facilitate simultaneous compression of mesh sock 18 around growing rope 26 and parting of mussels 20 within growing line 24, support device application region of apparatus 36 includes in a first preferred embodiment a first and second matched V-shaped jaw plate 120,124. First jaw plate 120 is arranged on and attached to a first jaw plate support 122 that is secured to applicator assembly 82 above right growing line guide wheel 76. Second jaw plate 124 is arranged on and attached to a second jaw support 126 that is secured to a vertical support plate 128 that is in turn attached to horizontal assembly support rail 56. The arrangement of jaw plates 120,124 is such that, in use, when growing line 24 is supplied to the support device application area of apparatus 36, movement of assembly 82 in the direction of arrow j (FIG. 5c) grabs growing line 24 within jaw plate 120 and moves the same into engagement with cooperating (preferably fixed) jaw plate 124. As best seen in FIG. 5d, growing line 24 is then compressed within jaw plates 120,124 by further movement of applicator assembly 82 toward jaw plate 124 in the direction of arrow j. This compression of growing line 24 within jaw plates 120,124 simultaneously parts socked mussels 20 and constricts mesh sock 18 around core growing rope 26. This action of apparatus 36 provides an opportunity for attachment of a support device 34. That is, the jaw plates 120,124 of apparatus 36 provide a means of precisely locating and holding firm core growing rope 26 of growing line 24 ready for attachment of support device 34.

Support devices 34 are provided to apparatus 36, ready for attachment, via a slide 130. Slide 130 cooperates with jaw plate 124 and is inclined relative thereto with its upper loading end secured to right side reinforcement plate 54. When loaded in a cartridge type fashion (as shown in FIGS. 3, 5a & 5c) into slide 130, support devices 34 are conveyed ready for application via a weight 132. It should be understood that although weight 132 is shown, support devices 34 could be conveyed in many other ways such as, for example, via the use of gravity or additional means (not shown) such as a spring loaded mechanism, and as such the invention is not intended to be limited to the specific given. Slide 130 cooperates with jaw plate 124 via a pair of support device guide rails 134 which precisely convey support devices 34 out of slide 130 ready for application to growing line 24. As can be seen in FIG. 5d, support device guide rails 134 are preferably lipped on their inner edges to define a recess 136 enclosed by jaw plate 124. Recess 136 cooperates with slide 130 to allow support devices 34 to travel out of slide 130 and towards the V-shaped periphery of jaw plate 124. Any suitable means (not shown) may be included to limit only one support device 34 from travelling out of slide 130 and onto jaw plate 124 ready for attachment to growing line 24. Similarly, any suitable means such as, for example, pivoting retaining tabs 137 (FIGS. 5a & 5c), may be used to temporarily retain support device 34 in position ready for application at or near V-shaped jaw plate 124. In use, once out of slide 130 and ready for attachment, support device 34 may be driven in the direction of arrow k (FIG. 5c) by a push arm 138 having a U-shaped periphery. If pivoting tabs 137 are utilized, the action of push arm 138 against support device 34 will drive the same past tabs 137 into engagement with growing line 24. Push arm 138 is seated between support device guide rails 134 and rests on jaw plate 124. Push arm 138 is actuated by a push arm ram 140 controlled by any suitable means (not shown), that is secured to frame 38 at one end and push arm 138 at its other end.

The overall operation of apparatus 36 facilitating socking of mussels 20 and attachment of support devices 34 to growing line 24, in one simultaneous action, shall now be described with reference to FIGS. 3, 5a, 5c & 5d. In these drawings it can be seen that apparatus 36 is being utilised to attach the support device 34 of FIG. 5b. As explained previously, support device 34 of FIG. 5b is an embodiment of an earlier invention claimed in Australian Patent Application No. 2003904988 (now PCT/AU04/01238) of the present Applicant. Support device 34 includes a body 142 having two angularly-disposed arm portions 144,146 joined at an intersection portion 148. Defined between arm portions 144,146 is an inwardly tapered slot 150, having opposed slot sides 152,154 and an apex 156 positioned relative to intersection portion 148. In use, tapered slot 150 is adapted to receive and engage growing line 24 in order to facilitate attachment thereto. When growing line 24 is introduced into inwardly tapered slot 150 and forced towards apex 156, growing line 24 is wedged into engagement with opposed slot sides 152,154, providing secure attachment of support device 34 to growing line 24.

Support device 34 also includes a support portion 158 which includes a support skirt 160. Extending perpendicular to inwardly tapered slot 150 and joined to respective sides of skirt 160 is a growing rope engaging support 162. Rope engaging support 162 provides additional support to support device 34 when the same is attached to growing line 24 by pressing against growing line 24 towards core growing rope 26 (FIGS. 5a & 5d). This additional support provided by rope engaging support 162 assists against pivotal movement of support device 34 relative to growing line 24 when exposed to mollusc growing arrangement 28 (FIG. 2). In use, and when attached to growing line 24, both body 142 and support portion 158 provide additional support area for mussel attachment to that provided by growing line 24.

To begin the overall operation, loaded mesh sock 18 is drawn away from socking applicator 98, over feed flange 96 and a knot 22 is tied in mesh sock 18 to enclose an end thereof. The knotted end 22 is then fed into insert 102 in the direction of arrow b (FIG. 4b) ready for injection with mussels 20. Growing rope 26, supplied via rope feed wheel 74, is then fed into the enclosed mesh sock 18. Seed mussels 20, loaded into hopper 86, are then supplied to enclosed mesh sock 18 containing growing rope 26 in the direction of arrows d, e via conveyor 90, through opening 88 and socking funnel 92. The now partially formed growing line 24 is drawn through insert 102 to continue the socking process. As growing line 24 comes out of insert 102 of socking applicator 98, past coupling 104, applicator assembly 82 is activated to draw growing line 24 toward fixed jaw plate 124 in the direction of arrow j. As assembly 82 is drawn toward jaw plate 124, jaw plate 120 engages growing line 24 and carries growing line 24 into engagement with cooperating jaw plate 124. Skirt 106 of coupling 104 assists growing line 24 as the same is drawn out of socking applicator 98 and forced toward second jaw plate 124. When jaw plates 120,124 are fully engaged and growing line 24 is firming held in the manner as discussed above, push arm 138 is activated and driven in the direction of arrow k in order to push support device 34 into engagement with the now compressed region of growing line 24 to attach support device 34 to growing line 24.

Support device 34 being ready for attachment having travelled off slide 130 and onto jaw plate 124 in cooperation with recess 136. Support device 34 is driven by force applied by the U-shaped periphery of push arm 138 against a substantially matched shaped intersecting portion 148 of support device 34. When driven fully into engagement with growing line 24, inwardly tapered slot 150 of support device 34 further compresses mesh sock 18 about growing rope 26 and wedges support device 34 into engagement with opposed slot sides 152,154 at or near apex 156. This wedged engagement facilitates attachment of support device 34 at a fixed location on growing line 24. Push arm 138 is then retracted opposite the direction of arrow k and the working action applied to applicator assembly 82 by ram 116 is released, retracting applicator assembly to its rest position in the direction of arrow i against the action of springs 114. This brings the operation of apparatus 36 to the stage shown in FIG. 5a, wherein a support device 34 is now securely attached to growing line 24 and a further support device 34 has moved into position on jaw plate 124 ready for application.

As the process of socking mussels 20 continues through the use of socking applicator 98, and further support devices 34 are applied in the manner as previously described (and as shown in FIG. 5c), growing line 24, having support devices 34 attached thereto, is drawn by drive wheel 64 with the assistance of guide wheels 76. Coming off drive wheel 64 is finished growing line 24 which resembles a continuous line of sausages being separated by support devices 34 (FIG. 3). Growing line 24 is now ready for application in mollusc growing arrangement 28 (FIG. 2) or the like in any suitable manner, ie. cut to required lengths or hung as one long-line looped up and down throughout growing environment 28.

The continual and precise operation of apparatus 36 is achieved through the use of control means (not shown) and a series of sensors or the like (not shown) which monitor distances and various stages of operation of apparatus 36. The control means being able to actuate drive wheel 64, rams 116,140 and to control the supply of mussels 20 through the use of conveyor 90.

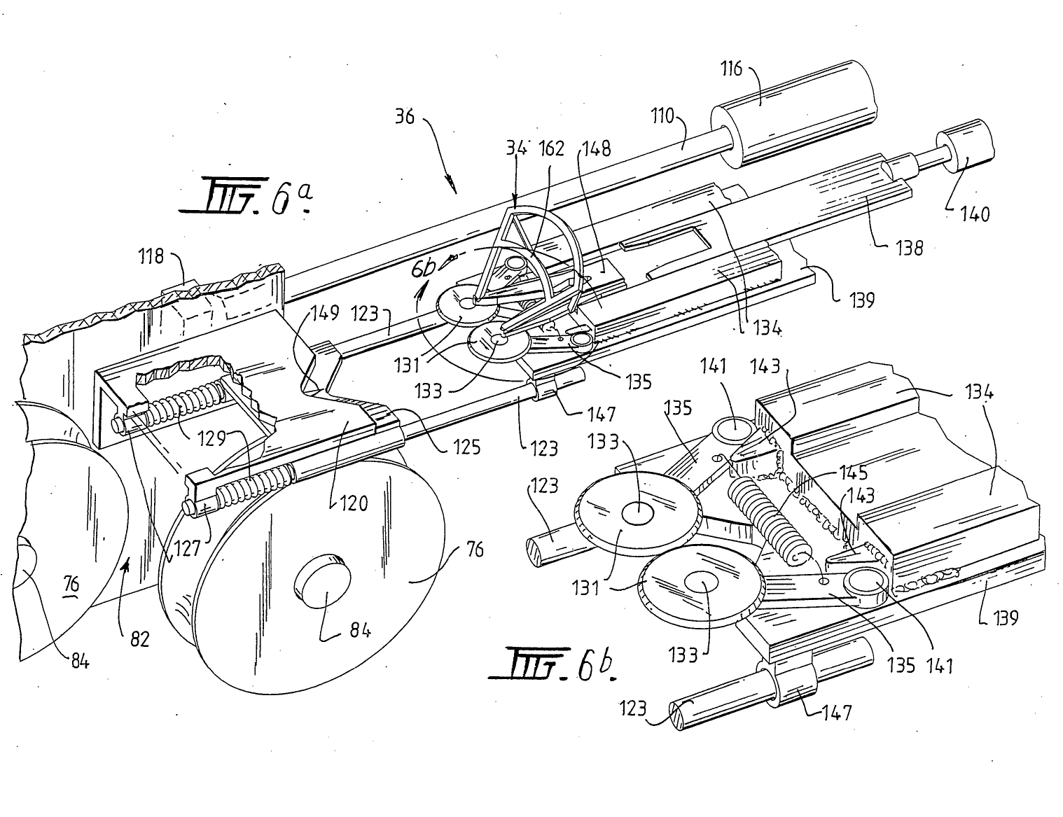

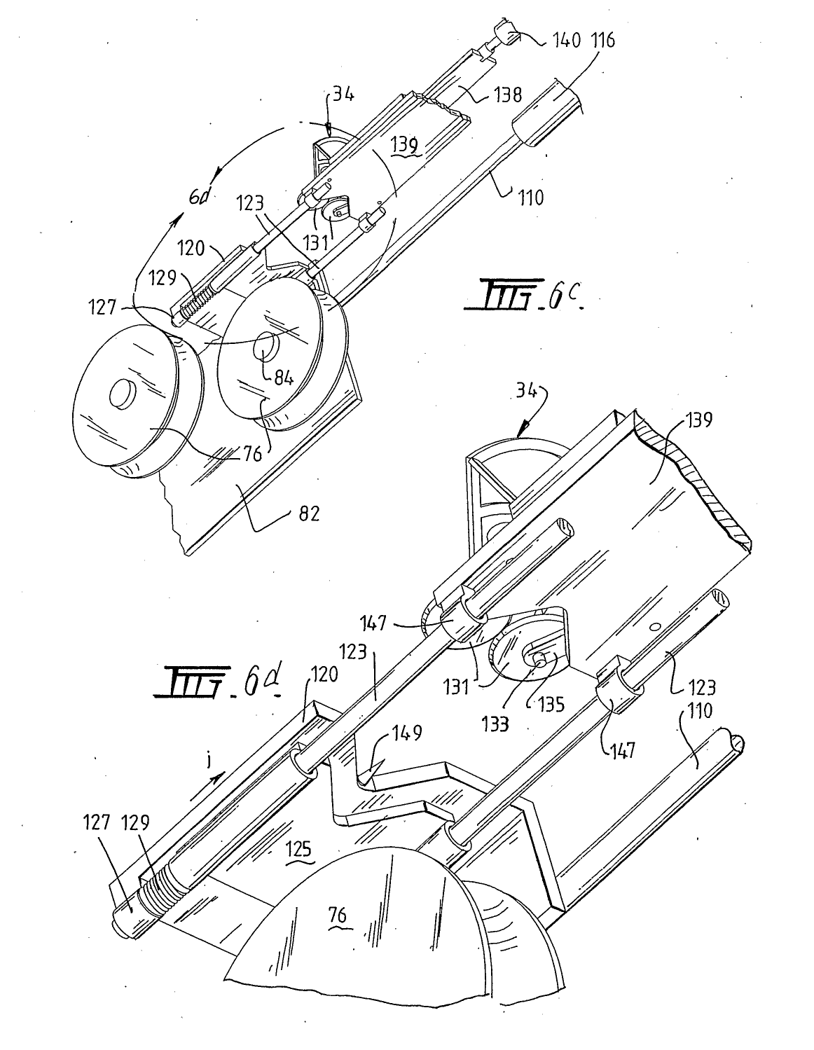

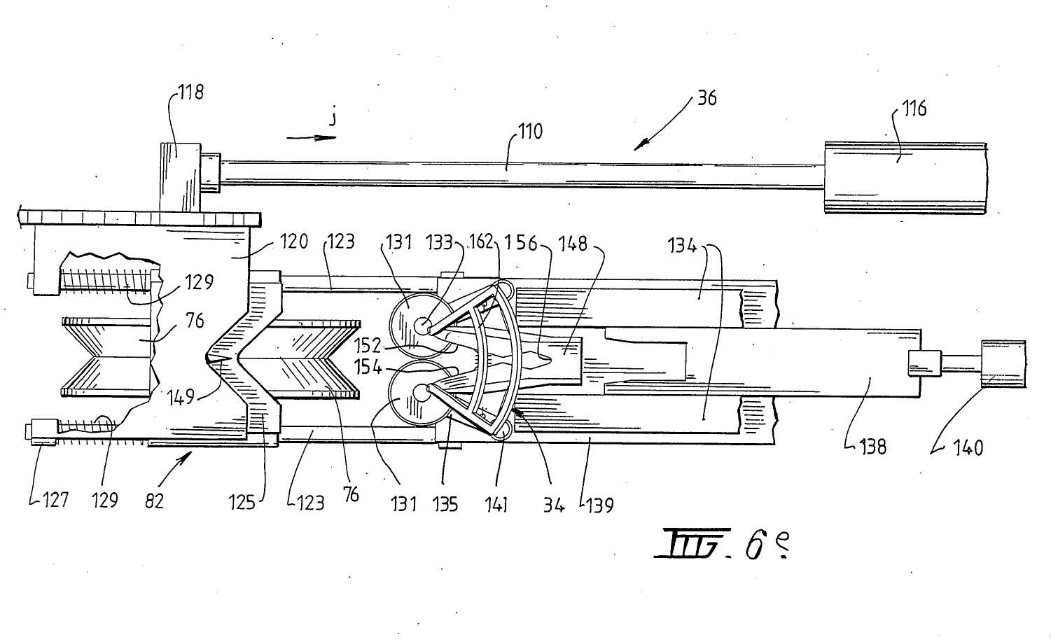

An apparatus for socking seed molluscs, especially mussels 20, and/or for applying support devices 34 to growing lines 24 made in accordance with a second preferred embodiment of the invention shall now be described with reference to FIGS. 6a to 6g. This apparatus 36 is also suitable for providing a growing line 24 for use in mollusc growing arrangement 28 of FIG. 2. In this embodiment only the support device application region of apparatus 36 is shown. It should be understood that apparatus 36 may also include the same of similar seed mollusc socking region as described with reference to the preceding embodiment. Where the support device application region of apparatus 36 differs from that of the apparatus described with reference to FIGS. 3 to 5d is that instead of having a simple arrangement of matched V-shaped jaws 120, 124, apparatus 36 includes a more complex arrangement of components designed to ensure that mesh sock 18 is not damaged during the application act. As discussed above the object of V-shaped jaws 120, 124 is to grab and hold growing line 24 ready for application of a support device 34. As growing line 24 is grabbed mesh sock 18 is compressed around internally located growing rope 26 at around the same time that mussels 20 are parted in the vicinity of jaws 120, 124. This action provides an attachment area substantially free of mussels 20 suitable for application with a support device 34. It has been found that jaws 120, 124 can sometimes damage (i.e. tear) mesh sock 18 during this action. Apparatus 36 as shown in FIGS. 6a to 6g substantially eliminates any damage to mesh sock 18 during application of a support device 34.

Referring to FIG. 6a, apparatus 36 includes first and second V-shaped applicator assembly jaw plates 120, 125. First jaw plate 120 is fixed to applicator assembly 82 at right angles, above right hand growing line guide wheel 76. Second jaw plate 125 is adapted to be movable with respect to a pair of applicator assembly guide rods 123. Guide rods 123 are arranged parallel to each other, side by side, and are fixed to and extend from a pair of couplings 127 arranged on the base of first jaw plate 120. Second jaw plate 125 includes outer tubular guideways for receiving guide rods 123 which facilitate left and right horizontal movement of second jaw plate 125. Second jaw plate 125 is biased to a rest position by a pair of springs 129. Springs 129 fit over and surround respective guide rods 123 and are arranged between couplings 127 and second jaw plate 125. The arrangement of second jaw plate 125 in association with guide rods 123 and springs 129 is such that upon force being applied to second jaw plate 125, springs 129 will absorb impact and allow second jaw plate 125 to move towards couplings 127. Once second jaw plate 125 has moved toward couplings 127 against the action of springs 129 (see FIG. 6d) the V-shaped periphery of first jaw plate 120 extends in front of second jaw plate 125 in the working directions of applicator assembly 82.

First and second jaw plates 120, 125 are designed to gently engage and drive growing line 24 towards a pair of freely rotating growing line engaging wheels 131. Rotating wheels 131 each rotate with respect to a pivot 133. Pivots 133 are each joined to a respective arm 135 which in turn is pivotally connected to a push arm support plate 139 via a pair of arm pivots 141. Push arm support plate 139 preferably has a V-shaped peripheral edge facing applicator assembly 82. Referring to FIG. 6b, it can be seen that rotating wheels 131 can each freely rotate with respect to pivots 133. Rotating wheels 131 substantially touch each other and form a nip between them in the working directions. At the same time wheels 131 may be parted in the direction of arrows x (FIG. 6f) when arms 135 are pivoted outwards with respect to arm pivots 141. To limit inward movement of arms 135 and in turn any overlap of wheels 131, a pair of arm stops 143 (FIG. 6b) are joined to push arm support plate 139. To ensure arms 135 are biased to a rest position wherein arms 135 substantially touch stops 143 and wheels 131 substantially touch each other, a spring 145 is included arranged between respective arms 135.

To ensure correct alignment of jaw plates 120, 125 and rotating wheels 131, guide rods 123 extend into and are slidably received within a pair of guide flanges 147 arranged at the base of push arm support plate 139. The arrangement of guide rods 123 and guide flanges 147 is such that upon ram 116 drawing application assembly 82 to the working directions guide rods 123 slide within guide flanges 147 and applicator assembly 82 having first and second jaw plates 120, 125 disposed thereon is drawn to rotating wheels 131.

The operation of apparatus 36 shall now be described with reference to FIGS. 6e to 6g. In FIG. 6e it can be seen that apparatus 36 is being utilised to attach a support device 34 similar to that shown and discussed with reference to FIG. 5b. It should be understood that apparatus 36 can be adapted to attach support devices 34 of varying forms and the invention is not limited to the particular example as shown. As a growing line 24 is fed into the support device application region of apparatus 36, applicator assembly 82 is activated by way of ram 116 and is drawn towards rotating wheels 131 in the direction of arrow j. As assembly 82 is drawn toward rotating wheels 131, second jaw plate 125 first engages growing line 24 and carries growing line 24 toward rotating wheels 131. As force is absorbed by springs 129, second jaw plate 125 moves towards couplings 127 and first jaw plate 120 also begins to engage growing line 24. As more working force is applied by ram 116 applicator assembly 82 moves further towards rotating wheels 131 which carries growing line 24 by way of jaw plates 120, 125 into engagement with the nip formed between respective rotating wheels 131. When growing line 24 is forced into engagement with the nip of rotating wheels 131, rotating wheels 131 rotate in the direction of arrows y (FIG. 6g) at about the same time arms 135 move outwards which in turn parts wheels 131 in the direction of arrow x (FIG. 6f). The rotation of wheels 131 in the direction of arrows y and the parting of wheels 131 in the direction of x compresses growing line 24 whilst at the same time drives growing line 24 past wheels 131 into and ready for engagement with support device 34. At this time push arm 138 is activated by ram 140 in the direction of arrow k to facilitate attachment of support device 34 to growing line 24 in a manner the same or similar to that previously discussed. Similarly, support device 34 may be supplied and fed onto push arm support plate 139, between guide rails 134, by a slide (not shown) the same or similar to that previously described.

The arrangement of jaw plates 120, 125 and rotating wheels 131 is such that growing line 24 is gently engaged and guided into wheels 131. Rotation of wheels 131 in the direction of arrows y then induces a rotation force on growing line 24 when growing line 24 is forced into the nip between respective wheels 131 which gently parts mussels 20 in the vicinity of rotating wheels 131 whilst at the same time constricts mesh sock 18 around core growing rope 26. This action, as compared to the action of jaw plates 120, 124 of the first preferred embodiment, is much gentler on mesh sock 18 which means mesh sock 18 is less likely to tear.

When push arm 138 is activated by ram 140 and a support device 34 is attached to growing line 24 the action of ram 116 is released such that further force applied by push arm 138 will drive growing line 24 back through rotating wheels 131 and thus the process can continue as desired. Applicator assembly may return to its starting position (FIG. 6a) by a reverse action applied by ram 116 or by way of springs (not shown) positioned on rods 110 as previously discussed.

What is also shown in FIGS. 6a to 6g is a skewer-type projection 149 arranged within the apex of first V-shaped jaw plate 120. Projection 149 is preferably included so that it may partially lodge itself into growing line 24 after growing line 24 has been moved toward rotating wheels 131 and second jaw plate 125 has retracted against the action of springs 129. Projection 149 provides a means of securely holding growing line 24 centrally of first jaw plate 120 whilst a support device 34 is attached thereto. It should be understood that projection 149 is not essential to the invention and is only included as an additional means of ensuring alignment of growing line 24 during the support device application act of apparatus 36.

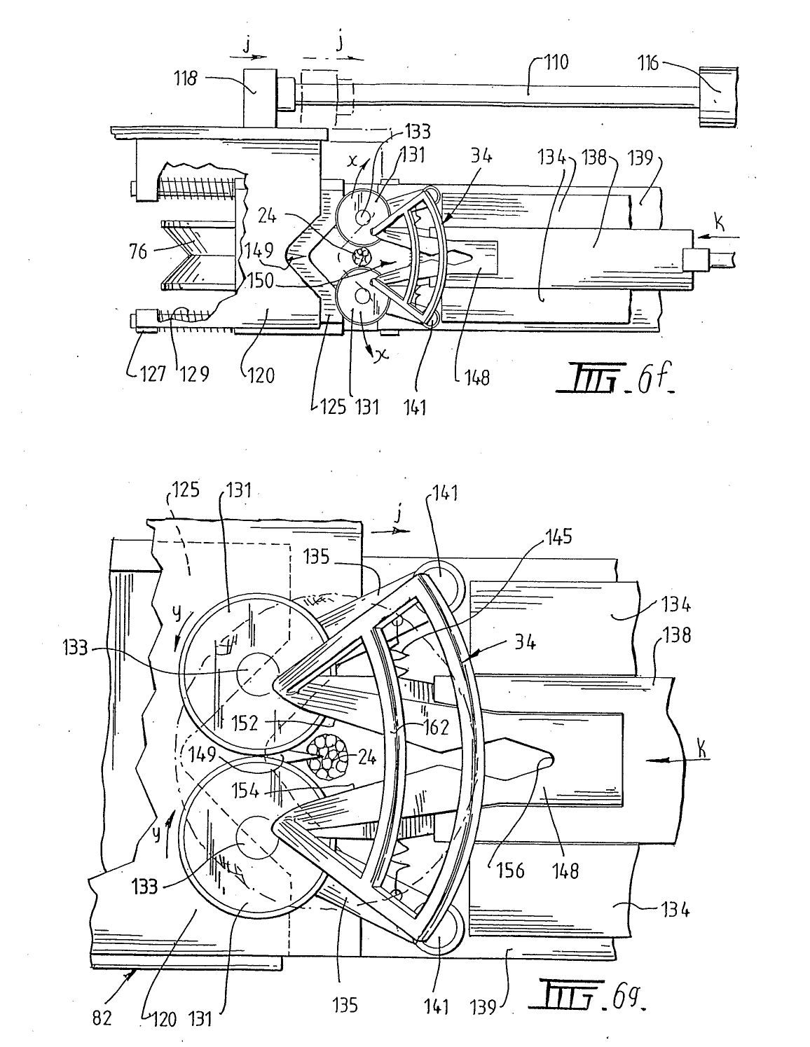

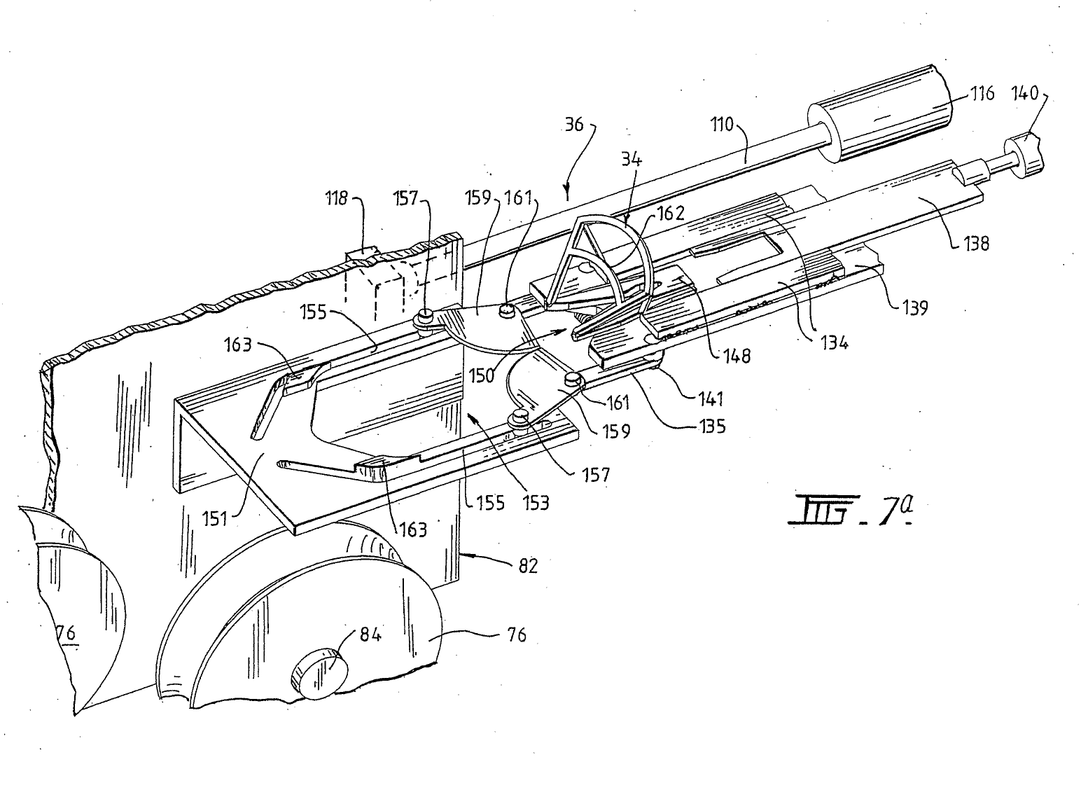

An apparatus for socking seed molluscs, especially mussels 20, and/or for applying support devices 34 to growing lines 24 made in accordance with a third preferred embodiment of the invention is shown in FIGS. 7a to 7f. Once again, like in the case of the preceding embodiment described with reference to FIGS. 6a to 6g, only the support device application region of apparatus 36 is shown. It should be understood that apparatus 36 may also include the same or similar seed mollusc socking region as described with reference to FIGS. 3 to 5d.

Once again apparatus 36 is designed to substantially eliminate mesh sock 18 damage during application of a support device 34. Referring particularly to FIG. 7a, apparatus 36 includes a control plate 151 attached to applicator assembly 82 above right hand growing line guide wheel 76. Control plate 151 includes a clearance gap 153 which is a substantially U-shaped cut out that has a width which is of a sufficient distance to receive therein growing line 24. Clearance gap 153 opens to the working direction j (FIG. 7e) of application assembly 82. Bordering U-shaped clearance gap 153 is a pair of matched control plate slots 155 which define a track from near the open end of control plate 151 to the rear of clearance gap 153. Received within slots 155 is a pair of quadrant pivots 157 which are affixed to a pair of quadrants 159. Quadrants 159 are attached to a pair of arms 135 via a pair of arm pivots 161. Arms 135 are in turn affixed to a push arm support plate 139 via a pair of push arm support plate pivots 141. Arms 135 are preferably biased towards one another by a spring 145. Push arm support plate 139 preferably has a V-shaped peripheral edge facing applicator assembly 82. The arrangement of pivots 141, 161, 157 is such that quadrants 159 along with arms 135 are able to move (pivot) as necessary when applicator assembly 82 is driven in the direction of arrow j by ram 116. When applicator assembly 82 is driven toward push arm support plate 139 in the direction of arrow j quadrant pivots 157 affixed to quadrants 159 travel down slots 155 in the track defined by slots 155 which in turn causes quadrants 159 to move inwardly of gap 153 and to pivot relative to arm pivots 161 as required. Arms 135 may also part as necessary and pivot relative to push arm support plate pivots 141 affixed to push arm support plate 139. As quadrants 159 travel across control plate 151 relative to quadrant pivots 157 within slots 155 arms 135 move inwards of clearance gap 153. Just prior to quadrant pivots 157 reaching the end of the track defined by slots 155 (FIGS. 7e and 7f) arms 135 are locked by means of a pair of raised control plate arm stops 163. The arrangement of arms 135 and control plate arm stops 163 is such that prior to arms 135 reaching arm stops 163, arms 135 can pivot outwards relative to push arm support plate pivots 141. When arms 135 pivot outwards quadrants 159 are parted such that they are no longer touching (FIG. 7c). After entering clearance gap 153, arms 135 are only able to pivot outwards in terms of the width of clearance gap 153, since upon entering clearance gap 153, arm pivots 161 will limit further outward movement of arms 135 by acting against the inner wall of clearance gap 153. When quadrants 159 have travelled along slots 155 relative to quadrant pivots 157, to a point just prior to quadrant pivots 157 reaching the end of slots 155 arm pivots 161 are guided by control plate arm stops 163 (FIG. 7f) which in turn forces arms 135 inwards and locks arms 135 from further outward movement, relative to push arm support plate pivots 141. This action causes quadrants 159 to rotate in the direction of arrows z relative to arm pivots 161 as quadrant pivots 157 travel the remaining distance to the end of slots 155. This rotation induces the required force to engage and draw growing line 24 through quadrants 159 to a point where growing line 24 is ready to have a support device 34 attached thereto (FIG. 7e).

The operation of apparatus 36 will now be described with reference to FIGS. 7d to 7f. In FIG. 7d it can be seen that a support device 34 has been loaded onto push arm support plate 139 by, for example, a slide (not shown). Support device 34 is loaded ready for application by a push arm 138 driven in the direction of arrow k by a ram 140. In its loaded position, support device 34 sits on push arm support plate 139 between push arm guide rails 134. When activated, ram 140 drives push arm 138 in the direction of arrow k between respective guide rails 134. The manner in which push arm 138 engages and drives support device 34 into engagement with growing line 24 has previously been described with reference to previous embodiments and is incorporated herein in its entirety.

In use, growing line 24 is supplied to support device application region of apparatus 36 by being fed into clearance gap 153. Applicator assembly 82 is then activated and drawn towards push arm support plate 139 in the direction of arrow j (FIG. 7e), by ram 116. As applicator assembly 82 is driven towards push arm support plate 139, quadrants 159 and arms 135 transverse clearance gap 153 by way of quadrant pivots 157 travelling within slots 155. Growing line 24 is engaged and moved by the rear of u-shaped clearance gap 153 as applicator assembly 82 is driven by ram 116. As applicator assembly 82 is driven further in the direction of arrow j, growing line 24 meets quadrants 159 as the same are gradually enclosing clearance gap 153. Growing line 24 is then forced into the nip formed between respective quadrants 159 which gently parts mussels 20 in the vicinity of quadrants 159 and at the same time starts to constrict mesh sock 18 around core growing rope 26. As the process of applicator assembly 82 continues and as quadrants 159 near the end of their predefined track defined by quadrant pivots 157, aim pivots 161 reach control plate arm stops 163 which locks arms 135 from moving outwards. Quadrants 159 then rotate in the direction of arrows z as quadrant pivots 157 finish their predefined track defined by slots 155.

During rotation of quadrants 159, growing line 24 is forced through quadrants 159 which further constricts mesh sock 18 around core growing rope 26 and supplies growing line 24 to support device 34 ready for attachment to the same. Push arm 138 is then activated in the direction of arrow k and support device 34 is applied in a manner similar or the same as that previously described.

After applying a support device 34, apparatus 36 releases or reverses the action applied to applicator assembly 82 by ram 116 which in turn moves applicator assembly 82 in the reverse direction of arrow j. This disengages the locking action applied to alms 135 by control plate arm stops 163 which in turn allows arms 135 to pivot outwards relative to push arm support plate pivots 141. Growing line 24 is then able to travel back through quadrants 159 as arms 135 pivot outwards and quadrants 159 part so that the application process of apparatus 36 may continue as desired.

As previously discussed, it is to be understood that the support device application region of apparatus 36 (according to any one of the embodiments described) could be adapted to be able to apply the known support devices of FIGS. 8a to 9b. The clip arrangement 164 of disc-shaped support device 34 of FIGS. 8a & 8b could be attached to growing line 24 by the action of a suitably shaped push arm 138. When pushed toward and into engagement with growing line 24, growing line 24 would be required to transverse generally C-shaped slot 166 of support device 34 and into engagement with clip 164. Similarly, support device 34 of FIGS. 9a & 9b would require suitable force applied by push arm 138 in order to skewer growing line 24 with support projection 168 arranged within C-shaped slot 170, to facilitate attachment with growing line 24 in the centre of support device 34. If required to apply devices such as those shown in FIGS. 8a to 9b, apparatus 36 could be adapted to include a substantially vertical slide (not shown) or stacking arrangement such that support devices 34 would be supplied to push arm 138 perpendicular to the working direction k of push arm 138.

An apparatus 36 for socking seed molluscs, especially mussels 20, and/or for applying support devices 34 to growing lines 24 made in accordance with a fourth preferred embodiment of the invention is shown in FIG. 10. This apparatus 36 also being suitable for providing a growing line 24 for use in the mollusc growing arrangement 28 shown in FIG. 2.

In this embodiment only the support device application region of apparatus 36 is shown. It is to be understood that this apparatus 36 may also include the same or similar seed mollusc socking region as described with reference to previous embodiments. The support device application region of apparatus 36 this time is designed to facilitate application of support devices 36 embodied as skewers. Instead of having slide 130, apparatus 36 includes a hopper 172 loaded with a plurality of skewers 34. Hopper 172 cooperates with a skewer application barrel (not shown) arranged at the base of hopper 172 which is supplied by gravity with a single skewer 34 from within hopper 172. A push arm 138 is adapted by any suitable means, such as, for example, via a ram (not shown), to push skewer 34 loaded in the application barrel through the same and into and through core growing rope 26 of growing line 24. Push arm 138 may be adapted to drive skewer 34 through the application barrel in a manner which would cause skewer 34 to rotate so that the same is screwed through core growing rope 26. A movable jaw 120 is adapted to be driven in the direction of arrow l towards and into engagement with a fixed jaw 124. The arrangement of jaws 120,124 is such that growing line 24 is compressed and held in a similar manner to that described above with reference to previous embodiments. An exit point of the barrel (not shown) is located between jaws 120,124 when the same are in engagement. When jaws 120,124 are driven fully into engagement in the direction of arrow l, and growing line 24 is held in the desired manner, push arm 138 is actuated in order to drive skewer 34 within the barrel out of the barrel exit point and through growing line 24. It is preferable that part of the now engaged skewer 34 remains in the barrel until after movable jaw 120 is retracted. At this point push arm 138 can be reactivated to push the remaining portion of skewer 34 out of the barrel. Thus permitting complete disengagement of skewer 34 from the barrel of the application region of apparatus 36. Push arm 138 then returns to its rest position, by any suitable means such as springs (not shown) or the like, permitting a further skewer 34 to drop into the barrel ready for application.

Ideally when mechanically socking mussels 20 and/or applying support devices 34 with apparatus 36 of any one of the embodiments described above, growing rope 26 and/or mesh sock 18 need to be provided to apparatus 36 in a continuous form. Growing ropes 26, for example, could be joined together before entering the mollusc socking region of apparatus 36 by a joining device 174 such as that shown in FIG. 11a and in enlarged view in FIG. 11b. Joining device 174 being adapted to join separate lengths of growing rope 26 prior to the socking action. If joining device 174 is utilised during the socking action, once the entire operation is completed by apparatus 36 and hence growing line 24 is formed, prior to hanging growing lines 24 in growing arrangement 28, separation of growing lines 24 could occur by cutting or tearing mesh sock 18 at the join relative to joining device 174. The now exposed joining device 174 could then be removed prior to attaching growing line 24 to horizontal support line 32 (FIG. 2).

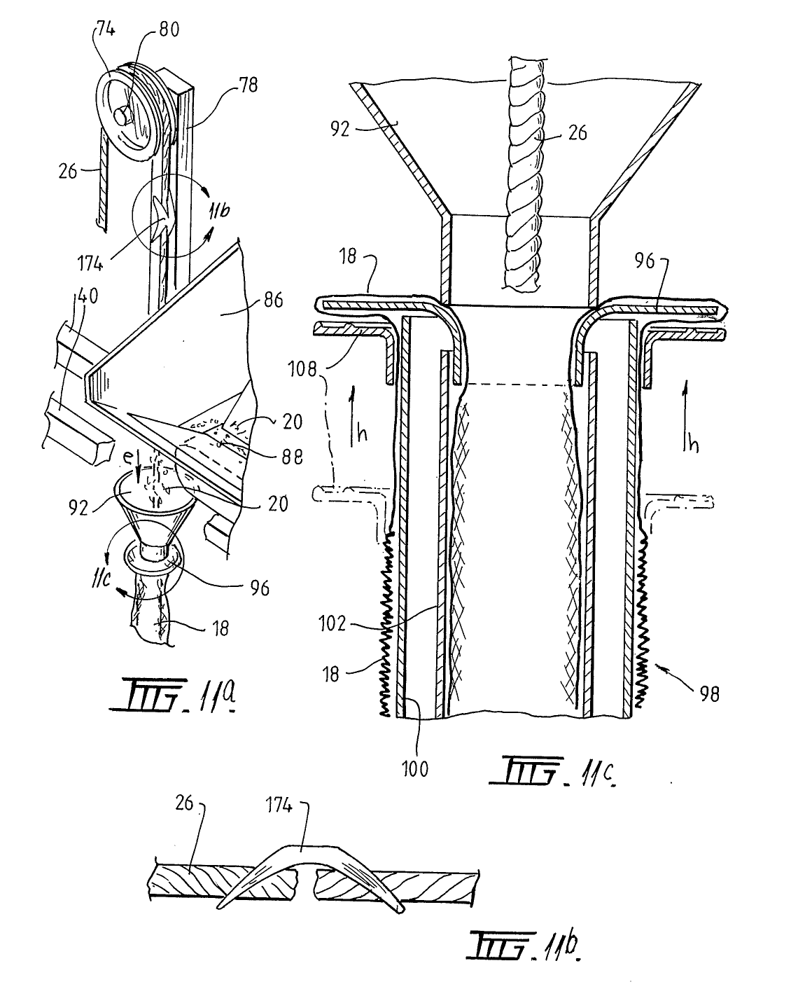

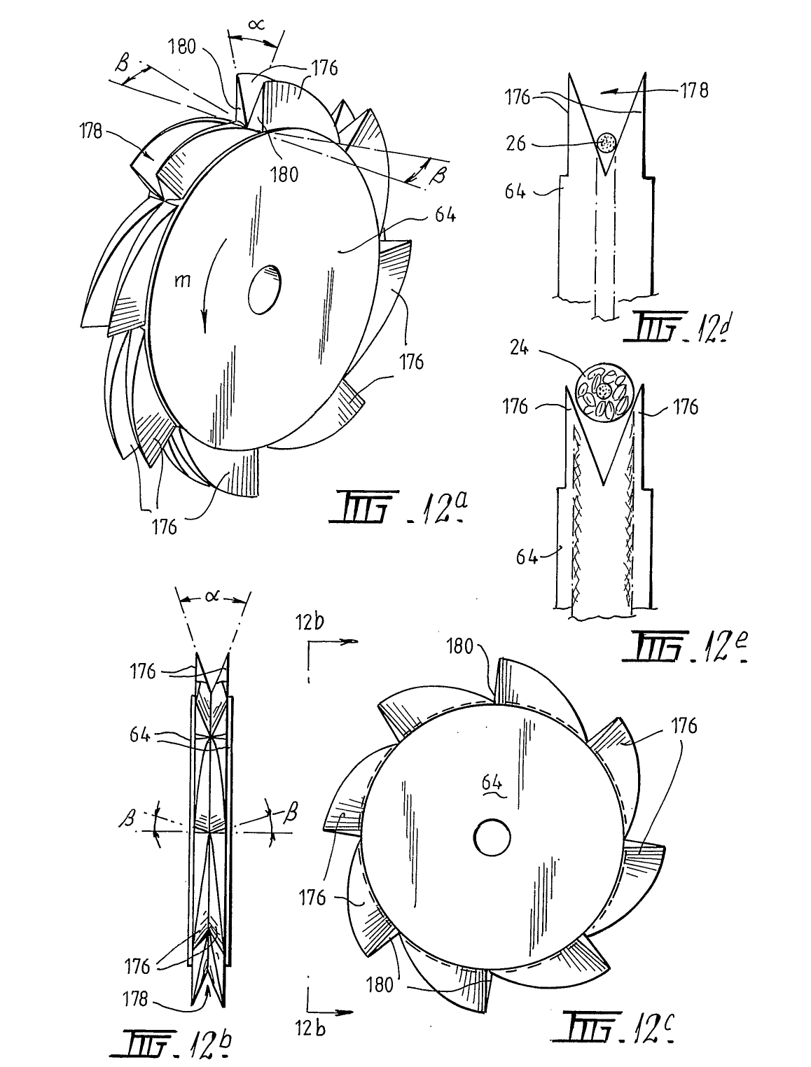

In a practical sense in any embodiment of apparatus 36 it is important that drive wheel 64 is able to securely engage growing line 24 to drive the same through apparatus 36. Growing line 24 should not be permitted to slip when engaged with drive wheel 64 when drive wheel 64 is rotating. When stationary, growing line 24 should be easily disengaged from drive wheel 64 to release growing line 24 when required. A preferred embodiment of drive wheel 64 is shown in FIGS. 12a to 12e. As can be seen in FIG. 12a, when adapted with apparatus 36, drive wheel 64 rotates in the direction of arrow m. Drive wheel 64 includes a series of paired upwardly projecting ridges 176 at its periphery. These ridges 176 define between matched pairs generally V-shaped recesses 178 having an appropriate angle α, for example 45 degrees. The specific choice of angle α depends on the mode of use of drive wheel 64 of apparatus 36. Referring to FIGS. 12d & 12e, it can be seen that V-shaped recess 178 of drive wheel 64 should be able to accommodate growing lines 24 of varying diameters, for example, apparatus 36 may be initially required to draw only growing rope 26 via drive wheel 64 (FIG. 12d), and later after the socking and support device application process has commenced, be able to drive socked growing line 24 (FIG. 12e). To assist in grabbing and driving growing line 24, ridges 176 of drive wheel 64 can include tapered front faces 180. Front faces 180 of ridges 176 being oriented to the drive direction m of drive wheel 64. Front faces 180 can be tapered at an angle β, for example 30 degrees, and can also be inclined relative to the periphery of ridges 176 to provide in combination with tapered faces 180 a grabbing force on growing line 24.

The grabbing force achieved by drive wheel 64 as embodied in FIGS. 12a to 12e, together with the spring tension arrangement of drive wheel 64 in FIG. 3 ensures that the overhanging and yet unseparated finished growing line 24 provides a resistance to slip and ensures forward movement of growing line 24 which is preferably required by apparatus 36 to facilitate the socking and support device application actions. The spring tension arrangement of drive wheel 64 also provides a required amount of release tension on growing line 24 after the support device application region of apparatus 36 has applied a support device 34. For example, in relation to the first preferred embodiment, this tension occurs naturally as growing line 24 is halted from travel temporarily by the action of jaws 120,124. When jaws 120,124 release, springs 72, attached to supports 68 associated with drive wheel 64 (FIG. 3), release built up tension and urge growing line 24 out of the support device application region relative to jaws 120,124 and back into motion.

It should be understood that although the application process of apparatus 36 has been shown with resect to a vertically arranged growing line 24, the socking and/or support device application regions of apparatus 36 could be adapted to sock molluscs, especially mussels 20, and/or apply support devices 34 to a growing line 24 oriented horizontally. In this alternative mode of operation (not shown) a support tray may be required for conveying the growing line 24. This support tray could be slotted so as to permit the raising of a lower jaw plate (not shown) from underneath the tray. This jaw plate could lift growing line 24 off the tray at that point toward a cooperating jaw (not shown) located above the tray. The application of a support device 34 could thereby occur by applying force to an appropriately positioned push arm (not shown) cooperating with supplied support devices 34. Appropriate means in cooperation with the push arm could engage support device 34 and release it from a cartridge type arrangement and convey it to core growing rope 26 of growing line 24 to facilitate attachment thereof. The lower jaw plate could then be retracted, allowing growing line 24 with an attached support device 34 to return to its rest position on the support tray. The support tray could be designed, if required, to slide away from the work area of the jaw plates to facilitate the removal of growing line 24 from the tray, for example, by inducing the tray to tip at a given point.

It should also be understood that as support device 34 of FIG. 5b is designed in a novel manner that enables itself to be easily attached to a growing line 24, as described in the initial paragraphs of this description, second jaw plate 124 of the first preferred embodiment shown in FIGS. 3, 5a to 5d may not require a V-shaped periphery. Instead, support device 34 may be conveyed partially over the edge of plate 124 such that inwardly tapered slot 150 of support device 34 could act as the second V-shaped jaw required to facilitate the parting and compressing action relative to growing line 24. Accordingly, second jaw plate 124 of the first embodiment of the accompanying representation is not essential to the invention if apparatus 36 is used in conjunction with an appropriately designed support device 34 of the present Applicant's own earlier Australian Patent Application No. 2003904988 (now PCT/AU04/01238).

Although not shown in the drawings, if a support device 34 used with apparatus 36 (of the first preferred embodiment) requires a larger constricted area of growing line 24 for attachment thereto, means (not shown) could be included to draw jaw plates 120,124 vertically apart after engagement with growing line 24, exposing a larger area of growing line 24 that has been freed of mussels 20 and constricted to locate growing rope 26. A support device 34 could then be attached to growing line 24 between the two parted jaw plates.

Although only specific examples of suitable support devices 34 and their application have been described, it is to be understood that many other support devices, each including means suitable for attachment to growing lines 24 could be applied with the apparatus 36 of the present invention. Similarly, it is to be understood that the adaptation of support devices 34 with apparatus 36 is not intended to be limited to use in the mussel cultivation area alone. Accordingly, support devices 34 for other areas of aquaculture, for example, scallop, fish or oyster cultivation, could be applied by apparatus 36.

The present invention therefore provides a useful solution to problems previously discussed in relation to the manual actions of socking mussels 20 and applying support devices 34 to socked growing lines 24, including the conventional skewer, the Applicant's own support device and those employed in the prior art. The invention solves the inherent problems associated with manual socking and application of mussels 20 and support devices 34 and the limitations stated relating thereto. Furtherstill, insert 102 of socking applicator 98 of apparatus 36 provides a novel means of achieving varying mussel density requirements, whilst jaws 120,124 and the varying arrangements shown in FIGS. 6a to 7f of the support device application region of apparatus 36 make it possible to automate the application process of many support devices 34. For example, jaws 120,124 ensure correct alignment of growing line 24 whilst facilitating constriction of mesh sock 18 around core growing rope 26 which provides the required secure attachment area for support devices 34.

The invention will be understood to embrace many further modifications as will be readily apparent to persons skilled in the art and which will be deemed to reside within the broad scope and ambit of the invention, there having been set forth herein only the broad nature of the invention and certain specific embodiments by way of example.

1-23. (canceled)

24. An apparatus for attaching at least one support device to at least one elongate mollusc growing line, said apparatus including: means for providing said at least one elongate mollusc growing line; means for providing said at least one support device for attachment to said at least one elongate mollusc growing line; means for releasably holding said at least one elongate mollusc growing line at a predefined location; and means for applying said at least one support device to said at least one elongate mollusc growing line whilst said at least one elongate mollusc growing line is held by said means for releasably holding said at least one elongate mollusc growing line.

25. The apparatus as claimed in claim 24, wherein said at least one elongate mollusc growing line is selected from one or more of the following: any suitable growing rope, any suitable growing rope that is socked with any suitable mesh sock, and/or any suitable mesh sock.

26. The apparatus as claimed in claim 24, wherein said at least one elongate mollusc growing line includes an elongate mesh sock which has been socked with molluscs and contains an elongate core growing rope.

27. The apparatus as claimed in claim 24, wherein said means for providing said at least one elongate mollusc growing line includes at least one drive wheel that is adapted to engage and draw said at least one elongate mollusc growing line through said apparatus.

28. The apparatus as claimed in claim 27, wherein said at least one drive wheel cooperates with at least one guide wheel capable of assisting said drawing of said at least one elongate mollusc growing line whilst said at least one elongate mollusc growing line is drawn through said apparatus.

29. The apparatus as claimed in claim 27, wherein said at least one drive wheel includes paired upwardly projecting ridges arranged around an outer periphery thereof.

30. The apparatus as claimed in claim 29, wherein said paired ridges define V-shaped recesses between respective pairs that are adapted to accommodate elongate mollusc growing lines of varying diameters.

31. The apparatus as claimed in claim 30, wherein said V-shaped recesses provide said at least one drive wheel with a means of engaging and driving elongate mollusc growing lines of varying diameters.

32. The apparatus as claimed in claim 29, wherein said paired ridges include tapered faces in the direction of travel of said at least one drive wheel to assist said at least one drive wheel in grabbing and engaging said at least one elongate mollusc growing line to drive said at least one elongate mollusc growing through said apparatus.

33. The apparatus as claimed in claim 24, wherein said means for providing said at least one support device includes at least one slide which cooperates with said means for applying said at least one support device, wherein said at least one support device is loaded onto said at least one slide ready for application by said means for applying said at least one support device.

34. The apparatus as claimed in claim 33, wherein said at least one slide is adapted to facilitate the supply of one support device at a time to said means for applying said at least one support device.

35. The apparatus as claimed in claim 33, wherein support devices are supplied in a queue via said at least one slide to said means for applying said at least one support device.

36. The apparatus as claimed in claim 33, wherein said at least one slide is adapted to receive at least one weight, wherein said at least one weight is adapted to be loaded onto said at least one slide after said at least one support device in order to drive said at least one support device to said means for applying said at least one support device.

37. The apparatus as claim in claim 36, wherein more than one support device is loaded onto said at least one slide in a cartridge form.

38. The apparatus as claimed in claim 24, wherein said means for releasably holding said at least one elongate mollusc growing line includes at least one set of mating jaws adapted to be drawn into engagement with one another in order to grab and releasably hold said at least one elongate mollusc growing line.

39. The apparatus as claimed in claim 38, wherein said at least one set of mating jaws include V-shaped opposed peripheral mating surfaces that, in use, engage and compress said at least one elongate mollusc growing line to facilitate simultaneous mollusc parting about said jaws, mesh sock compression relative to said elongate core growing rope and location of said elongate core growing rope within said mesh sock to provide an attachment area for said at least one support device.

40. The apparatus as claimed in claim 24, wherein said means for releasably holding said at least one elongate mollusc growing line includes at least one jaw plate which can engage and drive said at least one elongate mollusc growing line into and through a nip formed between at least one set of rotating wheels disposed on parallel axes, said at least one set of rotating wheels being adapted to engage and induce a rotational force on said at least one elongate mollusc growing line when said at least one elongate mollusc growing line is driven through said nip formed between said at least one set of rotating wheels.

41. The apparatus as claimed in claim 40, wherein said at least one jaw plate has a V-shaped peripheral engaging surface and said rotational force induced by said at least one set of rotating wheels engages and compresses said at least one elongate mollusc growing line to facilitate simultaneous mollusc parting about said at least one set of rotating wheels, mesh sock compression relative to said elongate core growing rope and location of said elongate core growing rope within said mesh sock to provide an attachment area for said at least one support device.

42. The apparatus as claimed in claim 24, wherein said means for releasably holding said at least one elongate mollusc growing line includes at least one control plate defining a generally U-shaped opening therein and including at least one slot bordering each side of said U-shaped opening, said slots defining at least one track for receiving and guiding at least two mating quadrants therein, said U-shaped opening being adapted to receive said at least one elongate mollusc growing line therein and, in use, to engage and drive said at least one elongate mollusc growing line into and through a nip formed between said at least two mating quadrants, said at least two mating quadrants adapted to engage and induce a rotational force on said at least one elongate mollusc growing line when said at least one elongate mollusc growing line is driven through said nip formed between said at least two mating quadrants.

43. The apparatus as claimed in claim 42, wherein said rotational force induced by said at least mating two quadrants in cooperation with said at least one control plate engages and compresses said at least one elongate mollusc growing line to facilitate simultaneous mollusc parting about said at least two mating quadrants, mesh sock compression relative to said elongate core growing rope, and location of said elongate core growing rope within said mesh sock to provide an attachment area for said at least one support device.

44. The apparatus as claimed in claim 39, wherein said attachment area is substantially free from molluscs and ready for attachment of said at least one support device by said means for applying said at least one support device.

45. The apparatus as claimed in claim 39, wherein said means for applying said at least one support device includes at least one push arm.

46. The apparatus as claimed in claim 45, wherein said at least one push arm is adapted, in use, to engage one support device from said at least one slide and to push said one support device into engagement with said at least one elongate mollusc growing line relative to said attachment area provided by said means for releasably holding said at least one elongate mollusc growing line.

47. The apparatus as claimed in claim 45, wherein said push arm is mechanically actuated by at least one ram means and/or any other suitable means able to drive said push arm.

48. The apparatus as claimed in claim 24, wherein said at least one support device is selected from one or more of the following group: a planar support plate; a disc-shaped support plate; a support structure incorporating a series of protrusions; a support structure incorporating a ring-like support area; a cage-like structure; and/or, any suitable combination thereof.

49. The apparatus as claimed in claim 48, wherein said at least one support device includes any suitable attachment means that is able to facilitate attachment to said at least one elongate mollusc growing line.

50. The apparatus as claimed in claim 49, wherein said attachment means is selected from one or more of the following group: an inwardly tapered slot for receiving said at least one elongate mollusc growing line therein and, in use, to wedge said at least one elongate mollusc growing line between opposed sides of said inwardly slot to facilitate attachment thereto; a skewer-like projection; and/or any suitable clip-type arrangement.

51. The apparatus as claimed in claim 24, wherein said means for releasably holding said at least one elongate mollusc growing line includes at least one jaw plate for receiving therein said at least one elongate mollusc growing line, and at least one push arm for engaging and driving said at least one elongate mollusc growing line into said at least one jaw plate such that, in use, said at least one elongate mollusc growing line is releasably held in a compressed state in said at least one jaw plate by said at least one push arm.

52. The apparatus as claimed in claim 51, wherein said means for providing said at least one support device includes at least one hopper, and wherein said means for applying said at least one support device includes at least one support device engaging push arm adapted to engage at least one support device from within said at least one hopper and to drive said at least one support device through said at least one elongate mollusc growing line whilst said at least elongate mollusc growing line is releasably held in said compressed state.

53. The apparatus as claimed in claim 51, wherein said at least one support device is at least one skewer.

54. The apparatus as claimed in claim 24, wherein said at least one elongate mollusc growing line having at least one support device attached thereto is adapted to be suspended below the surface of water in order to provide a growing environment for molluscs during their growth.

55. The apparatus as claimed in claim 24, wherein said at least one support device is attachable to said at least one elongate mollusc growing line at any fixed location.

56. The apparatus as claimed in claim 24, wherein a body portion of said at least one support device is adapted to provide additional support area for said molluscs to attach to or be supported by as they grow.

57. An apparatus for providing at least one elongate mollusc growing line having at least one support device attached thereto, said apparatus including: means for supplying at least one elongate sock for injection with molluscs; means for injecting said molluscs into said at least one elongate sock; and means for driving said at least one elongate sock through said apparatus, wherein, in use, said injection means continually socks said molluscs into said at least one elongate sock as said at least one elongate sock is conveyed by said driving means to provide said at least one elongate mollusc growing line; means for providing said at least one support device for attachment to said at least one elongate mollusc growing line; means for releasably holding said at least one elongate mollusc growing line at a predefined location; and means for applying said at least one support device to said at least one elongate mollusc growing line whilst said at least one elongate mollusc growing line is held by said means for releasably holding said at least one elongate mollusc growing line.

58-105. (canceled)

106. A method for attaching at least one support device to at least one elongate mollusc growing line, said method including the steps of: providing said at least one elongate mollusc growing line; providing said at least one support device for attachment to said at least one elongate mollusc growing line; releasably holding said at least one elongate mollusc growing line at a predefined location; and applying said at least one support device to said at least one elongate mollusc growing line whilst said at least one elongate mollusc growing line is releasably held.

107. The method as claimed in claim 106, wherein said at least one elongate mollusc growing line is selected from one or more of the following: any suitable growing rope, any suitable growing rope that is socked with any suitable mesh sock, and/or any suitable mesh sock.

108. The method as claimed in claim 106, wherein said at least one elongate mollusc growing line includes an elongate mesh sock which has been socked with molluscs and contains an elongate core growing rope.

109. The method as claimed in claim 108, wherein said step of releasably holding said at least one elongate mollusc growing line provides an attachment area for said at least one support device to be applied to said at least one elongate mollusc growing line, said attachment area being substantially free from molluscs and said elongate core growing rope being located within said elongate mesh sock to facilitate attachment of said at least one support device to said at least one elongate mollusc growing line.

110. The method as claimed in claim 106, wherein said at least one support device is selected from one or more of the following group: a planar support plate; a disc-shaped support plate; a support structure incorporating a series of protrusions; a support structure incorporating a ring-like support area; a cage-like structure; and/or, any suitable combination thereof.

111. The method as claimed in claim 106, wherein said at least one support device includes any suitable attachment means that is able to facilitate attachment of said at least one support device to said at least one elongate mollusc growing line.

112. The method as claimed in claim 111, wherein said attachment means is selected from one or more of the following group: an inwardly tapered slot for receiving said at least one elongate mollusc growing line therein and, in use, to wedge said at least one elongate mollusc growing line between opposed sides of said inwardly slot to facilitate attachment thereto; a skewer-like projection; and/or any suitable clip-type arrangement.

113. The method as claimed in claim 106, further including the step of suspending said at least one elongate mollusc growing line having said at least one support device attached thereto below the surface of water in order to provide a growing environment for said molluscs during their growth.

114. The method as claimed in claim 106, wherein more than one support device is applied to said at least one elongate mollusc growing line at any predefined location.

115. The method as claimed in claim 106, wherein a body portion of said at least one support device is adapted to provide additional support area for said molluscs to attach to or be supported by as they grow.

116-124. (canceled)
